(19) United States
(12) Patent Application Publication
(10) Pub. No.: US 2025/0220397 A1
(43) Pub. Date: Jul. 3, 2025

(54) ELECTRONIC DEVICE, METHOD, AND STORAGE MEDIUM FOR WIRELESS COMMUNICATION

(71) Applicant: Sony Group Corporation, Tokyo (JP)

(72) Inventors: Lantao LI, Beijing (CN); Chen SUN, Beijing (CN)

(73) Assignee: Sony Group Corporation, Tokyo (JP)

(21) Appl. No.: 18/850,051

(22) PCT Filed: Mar. 28, 2023
(86) PCT No.: PCT/CN2023/084415

§ 371 Date: Sep. 23, 2024

(30) Foreign Application Priority Data
Mar. 31, 2022 (CN) 202210335576.8

(51) Int. Cl. H04W 4/40; H04B 7/04; H04L 43/091; H04W 4/02

(52) U.S. Cl. CPC H04W 4/40; H04B 7/04013; H04L 43/091; H04W 4/027

(57) ABSTRACT

The present disclosure relates to an electronic device, method, and storage medium for wireless communication. Various embodiments for enhancing sidelink (SL) performance are described. In an embodiment, the electronic device comprises a processing circuit, and the processing circuit is configured to: determine a V2X communication policy for a specific region, wherein the V2X communication policy comprises at least one of service control information, communication assistance information, and transmission control information; and transmit the V2X communication policy, enabling a first terminal device to obtain the V2X communication policy.

### TECHNICAL FIELD

The present disclosure generally relates to a device and method for wireless communication, including technologies for enhancing communication performance in use of sidelink (SL) (for example, in scenarios of device to device (D2D), vehicle to everything (V2X), and the like).

### BACKGROUND

In communication systems (for example, LTE communication systems and NR communication systems), the SL is introduced to support D2D communication. Via the SL, communication between terminal devices can be supported within or out of network coverage. Communication between terminal devices can be performed via the SL even if the terminal devices are out of network coverage.

As a specific application of D2D communication, V2X communication can be performed by transmitting and receiving intelligent transportation system (ITS) messages, for example, specified by the European Telecommunication Standards Institute (ETSI) to implement safe driving of vehicles. In V2X scenarios, vehicle information is provided through sensors, vehicle-mounted terminals, and electronic tags installed on the vehicles to implement interconnection and interworking of vehicle to vehicle (V2V), vehicle to pedestrian (V2P), vehicle to infrastructure (V2I), and vehicle to network (V2N) by using various communication methods including the SL. The vehicle information can be extracted and shared on an information network platform to facilitate vehicle control and provide comprehensive services.

It should be noted that communication performance (such as reliability and stability) of the SL is very important to ensure the performance and quality of service of D2D communication and V2X communication. In corresponding scenarios, it is expected to enhance the communication performance of the SL.

### SUMMARY

A first aspect of the present disclosure relates to an electronic device including a processing circuit configured to: determine a V2X communication policy for a specific area, where the V2X communication policy includes at least one of service control information, communication assistance information, and transmission control information; and transmit the V2X communication policy, enabling a first terminal device to obtain the V2X communication policy.

A second aspect of the present disclosure relates to an electronic device including a processing circuit configured to: receive one or more V2X communication policies, where the one or more V2X communication policies are used for respective areas; based on its own location, determine a first V2X communication policy corresponding to its own location from the one or more V2X communication policies, where the first V2X communication policy includes at least one of service control information, communication assistance information, and transmission control information; and apply the first V2X communication policy.

A second aspect of the present disclosure relates to a Reconfigurable Intelligent Surface (RIS) device including a processing circuit configured to: receive a first assistance transmission request from a first terminal device, the first assistance transmission request indicating at least one of: a location, expected speed, or expected route of the first terminal device; information about a target node; or a V2X service type or priority. The processing circuit is further configured to: based on the first assistance transmission request, determine that the RIS device is to provide assistance transmission for the first terminal device; and transmit a first message to the first terminal device.

A fourth aspect of the present disclosure relates to an electronic device for implementing a network function. The electronic device includes a processing circuit configured to: based on a resonance frequency of an electromagnetic unit of a Reconfigurable Intelligent Surface (RIS) device, determine frequency information for communication between a first terminal device and the RIS device; and indicate the frequency information to the first terminal device over a network.

A fifth aspect of the present disclosure relates to various methods for communication, including operations or any combination of operations performed by, for example, the electronic devices described above.

A sixth aspect of the present disclosure relates to a computer-readable storage medium having executable instructions stored thereon, where the executable instructions, when executed by one or more processors, cause implementation of operations of the method.

A seventh aspect of the present disclosure relates to a computer program product, where the computer program product includes instructions which, when executed by a computer, cause implementation of the method according to various embodiments in the present disclosure.

The above summary is provided to summarize some exemplary embodiments in order to provide a basic understanding of the various aspects of the subject matter described herein. Therefore, the above-described features are merely examples and should not be construed as limiting the scope or spirit of the subject matter described herein in any way. Other features, aspects, and advantages of the subject matter described herein will become apparent from the Detailed Description described below in conjunction with the drawings.

### BRIEF DESCRIPTION OF DRAWINGS

A better understanding of the present disclosure can be achieved by referring to the detailed description given hereinafter in connection with the accompanying drawings. The same or similar reference numerals are used in the accompanying drawings to denote the same or similar components. The accompanying drawings together with the following detailed description are included in the specification and form a part of the specification, and are used to exemplify the embodiments of the present disclosure and explain the principles and advantages of the present disclosure. where:

FIG. 1 illustrates an example block diagram of a communication system according to an embodiment of the present disclosure.

FIG. 2 illustrates an example V2X system structure according to an embodiment of the present disclosure.

FIG. 3 illustrates another example V2X system structure according to an embodiment of the present disclosure.

FIG. 4A illustrates an example electronic device capable of implementing a control device according to an embodiment of the present disclosure.

FIG. 4B illustrates an example electronic device capable of implementing a terminal device according to an embodiment of the present disclosure.

FIG. 4C illustrates an example electronic device for frequency allocation according to an embodiment of the present disclosure.

FIG. 5 illustrates an example V2X communication policy according to an embodiment of the present disclosure.

FIG. 6 illustrates an example signaling flow for determining a V2X communication policy according to an embodiment of the present disclosure.

FIG. 7 illustrates an example signaling flow for establishing assistance transmission according to an embodiment of the present disclosure.

FIG. 8 illustrates example processing for controlling assistance transmission based on a transmission distance according to an embodiment of the present disclosure.

FIG. 9 illustrates another example signaling flow for establishing assistance transmission according to an embodiment of the present disclosure.

FIG. 10A illustrates an example RIS device according to an embodiment of the present disclosure.

FIG. 10B illustrates an example of performing electromagnetic wave transmission using a RIS.

FIG. 11A and FIG. 11B each illustrate an example signaling flow for allocating a frequency for a PC5 interface according to an embodiment of the present disclosure.

FIG. 12A to FIG. 12D each illustrate an example method for communication according to an embodiment of the present disclosure.

FIG. 13 is an example block diagram of a computer capable of being implemented as a terminal device or control device according to an embodiment of the present disclosure.

FIG. 14 is a block diagram illustrating a first example of a schematic configuration of a gNB to which the technology of the present disclosure can be applied.

FIG. 15 is a block diagram illustrating a second example of a schematic configuration of a gNB to which the technology of the present disclosure can be applied.

FIG. 16 is a block diagram illustrating an example of a schematic configuration of an smartphone to which the technology of the present disclosure can be applied.

FIG. 17 is a block diagram illustrating an example of a schematic configuration of a car navigation device to which the technology of the present disclosure can be applied.

Although the embodiments described in the present disclosure may have various modifications and alternatives, specific embodiments thereof are illustrated as examples in the accompany drawings and described in detail in this specification. It should be understood that the drawings and detailed description thereof are not intended to limit embodiments to the specific forms disclosed, but to cover all modifications, equivalents, and alternatives falling within the spirit and scope of the claims.

### DESCRIPTION OF EMBODIMENTS

The following describes representative applications of various aspects of the device and method according to the present disclosure. The description of these examples is merely to add context and help to understand the described embodiments. Therefore, it is clear to those skilled in the art that the embodiments described below can be implemented without some or all of the specific details. In other instances, well-known process steps have not been described in detail to avoid unnecessarily obscuring the described embodiments. Other applications are also possible, and the solution of the present disclosure is not limited to these examples.

Generally, all terms used herein will be interpreted in accordance with their ordinary meaning in the related art, unless different meanings and/or implications are clearly given in the context nless otherwise expressly stated, references to elements, apparatuses, components, units, and operations are intended to be interpreted openly as at least one instance of the elements, the apparatuses, the components, the units, and the operations. Operations of any method disclosed herein need not be performed in the exact order disclosed unless the operations are explicitly or implicitly described after or before another operation. Any feature of any embodiment disclosed herein may be applied to any other suitable embodiment. Similarly, any advantage of any embodiment may be applied to any other embodiment, and vice versa. Other objects, features, and advantages of the embodiments will become apparent from the following descriptions.

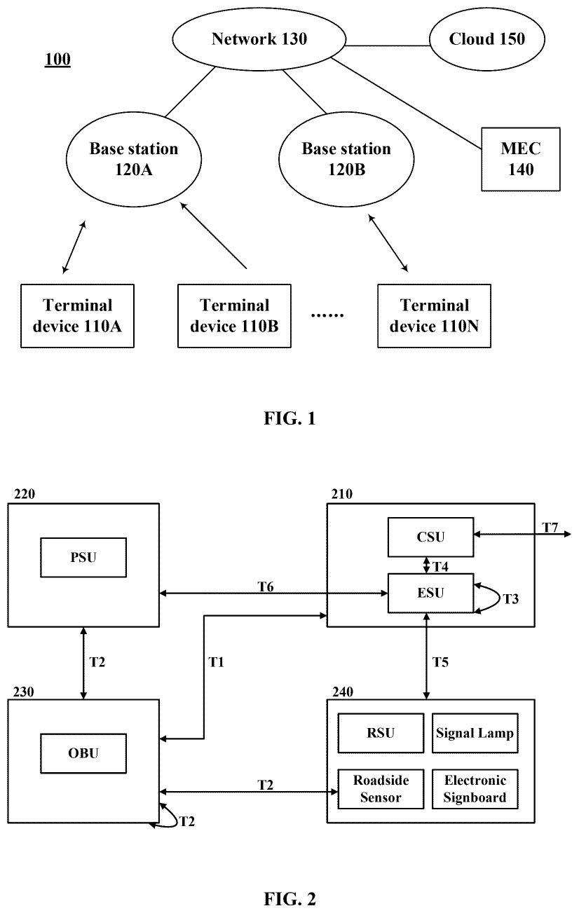

FIG. 1 illustrates an example block diagram of a communication system according to an embodiment of the present disclosure t should be noted that FIG. 1 illustrates only one of multiple types and possible layouts of wireless communication systems, and features of the present disclosure can be implemented in any one of the various systems as required.

As shown in FIG. 1, the communication system 100 includes base stations 120A and 120B, and terminal devices 110A, and 110B to 110N. The base stations and the terminal devices can be configured to perform uplink and downlink communication through Uu interfaces. The base stations 120A and 120B may communicate with a network 130 (for example, a core network of a cellular service provider, a telecommunications network such as a public switched telephone network (PSTN), and/or the Internet). Therefore, the base stations 120A and 120B may facilitate communication between the terminal devices 110A to 110N and/or between the terminal devices 110A to 110N and the network 130. Further, the terminal devices 110A to 110N can perform SL communication within a valid communication range through a PC5 interface.

In FIG. 1, coverage areas of the base stations 120A and 120B may be referred to as cells. Base stations operating with one or more cellular communication technologies may provide continuous or nearly continuous communication signal coverage to the terminal devices 110A to 110N over a wide geographic area.

As shown in FIG. 1, the communication system 100 includes a cloud 150 and a mobile edge computing (MEC) 140. The cloud 150 may provide services such as IaaS, PaaS, and SaaS to the terminal devices through a connection to the network 130. In the cloud 150 and the MEC 140, computing resources can be deployed to provide support for meeting computing requirements of communication services (such as communication computing convergence services).

In the present disclosure, the base station may be a 5G NR base station, such as a gNB and an ng-eNB. The gNB may provide NR user plane and control plane protocols for terminating with the terminal devices. The ng-eNB is a node defined for compatibility with the 4G LTE communication system, which may be an upgrade of an evolved NodeB (eNB) of an LTE radio access network, providing an evolved universal terrestrial radio access (E-UTRA) user plane and control plane protocols for terminating with UEs. In addition, examples of the base station may include but are not limited to the following: at least one of a base transceiver station (BTS) and a base station controller (BSC) in a GSM system; at least one of a radio network controller (RNC) and a Node B in a WCDMA system; access points (APs) in WLAN and WiMAX systems; and corresponding network nodes in communication systems to be developed or under development. Part of functions of a base station herein can also be implemented as an entity that has control functions to communication in D2D, M2M, and V2X communication scenarios, or as an entity that plays a role of spectrum coordination in the cognitive radio communication scenario.

In the present disclosure, the terminal device may have the full breadth of its ordinary meaning, for example, the terminal device may be a mobile station (MS), user equipment (UE), and so on. The terminal device can be implemented as a device such as a mobile phone, a handheld device, a media player, a computer, a laptop computer, a tablet computer, an on board unit (OBU), a vehicle, a roadside unit (RSU), or a wireless device of almost any type. In some cases, the terminal device may communicate using multiple wireless communication technologies. For example, the terminal device may be configured to communicate using one or more of GSM, UMTS, CDMA2000, WiMAX, LTE, LTE-A, WLAN, NR, Bluetooth, and so on. Embodiments will be described with reference to vehicles, OBUs, and the like. However, it should be understood that these embodiments are applicable to any type of terminal device.

In the present disclosure, terminal devices may work in V2X scenarios based on PC5 interfaces. V2X communication is intended to connect vehicles to everything. The V2X technology defined by the 3GPP standards organization is mainly based on cellular networks (Cellular), so it is called C-V2X, specifically including LTE-V2X based on 4G networks and NR-V2X based on 5G networks.

In V2X scenarios, vehicles can communicate with each other via V2X communication while relying on or not relying on base stations. Specifically, vehicles can exchange data over a specific distance through the SL. In the SL, either mode 1- or mode 2-based PC5 interfaces or mode 3- or mode 4-based PC5 interfaces may be used. Mode 3 may be referred to as a scheduling resource allocation mode, being a V2X communication mode in which the base station performs SL scheduling (for example, through Uu interfaces). Mode 4 may be referred to as autonomous resource selection mode, being a V2X communication mode in which the vehicle independently selects SL resources without the help of the base station. In both mode 3 and mode 4, the PC5 interface is used for V2X communication between vehicles. In mode 3, the Uu interface is also used for obtaining SL scheduling information between the vehicle and the base station.

FIG. 2 illustrates an example V2X system structure according to an embodiment of the present disclosure. The system structure may be used to implement a cooperative intelligent transportation system (C-ITS). In C-ITS, intelligent collaboration and cooperation for vehicle to infrastructure, vehicle to vehicle, and vehicle to pedestrian are implemented.

As shown in FIG. 2, the C-ITS may include a central sub-system (CSS) 210, a personal sub-system (PSS) 220, a vehicle sub-system (VSS) 230, and a road sub-system (RSS) 240.

The central sub-system 210 may include a variety of devices for traffic scheduling, planning, control, and the like, and is responsible for coordinating global and local regional traffic activities. These devices include, for example, a central service unit (CSU) and an edge service unit (ESU). The personal sub-system 220 may include personal service units (PSUs). The vehicle sub-system 230 may include OBUs. The road sub-system 240 may include a variety of devices including RSUs, road sensors, road traffic facilities, and roadside computing facilities, which are responsible for collecting and reporting road traffic information, controlling traffic flow, and communicating with other sub-systems.

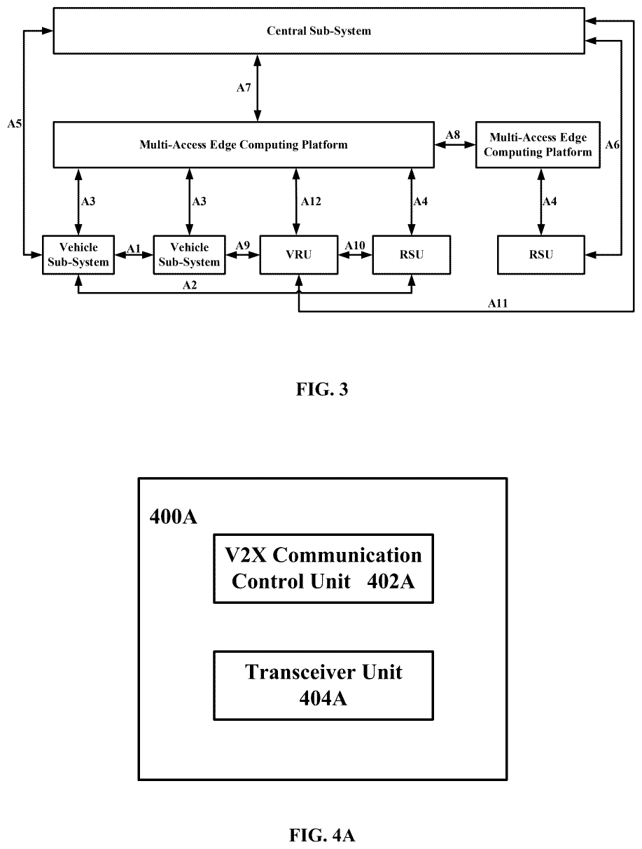

FIG. 3 illustrates another example V2X system structure according to an embodiment of the present disclosure. The system structure may be used to implement an enhanced V2X service application architecture.

In FIG. 3, the central sub-system has the capability of communicating with the vehicle sub-system and road sub-system. The central sub-system has capabilities of global data reception, storage processing, and distribution, and is responsible for global information sensing and global service policy control. The road sub-system may include one or more of roadside unit (RSU), multi-access edge computing platform, and roadside sensing device.

In the V2X scenario, the vehicle is used as a representative of terminal devices. From the perspective of the vehicle, the vehicle itself is in a moving state, and the PC5 interface-based SL between vehicles may also keep changing. For example, movement of the vehicles may cause SL channel quality to change, making an original transmission path no longer suitable for a current V2X service. In addition, due to movement of the vehicles, the communication status, road environment, or road traffic associated with the area may change from the perspective of the control device responsible for managing V2X communication (the control device generally controls V2X communication within a specific area). Correspondingly, V2X services that are expected or allowed to be performed within the area may change. In the present disclosure, the control device may be responsible for managing V2X communication policies for terminal devices, including vehicles, within a specific area. It should be noted that the area herein may be any area that the vehicle may travel through or stay in, for example, the area may be marked on a map (such as a high-precision map) or the area may be marked by an electronic fence. Examples of areas may include road areas formed by specific roads and intersections (such as road sections, intersections, or bridges) or specific scenes (such as blocks, parking lots, gas stations, or service areas). This is not limited in the present disclosure.

### Examples of the Electronic Device

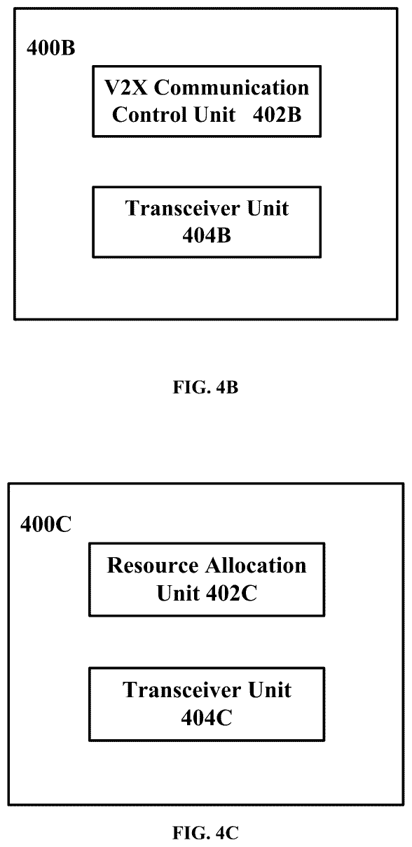

FIG. 4A illustrates an example electronic device capable of implementing a control device according to an embodiment of the present disclosure. The electronic device 400A may include various units to implement embodiments for configuring V2X communication on the network side according to the present disclosure. In the example of FIG. 4A, the electronic device 400A includes a V2X communication control unit 402A and a transceiver unit 404A. The various operations described below with reference to the control device or the control function may be implemented by units 402 to 404 or other possible units of the electronic device 400A.

In an embodiment, the V2X communication control unit 402A may be configured to determine a V2X communication policy for a specific area based on at least one of communication status information, road environment information, and road traffic information associated with the specific area. In an embodiment, the V2X communication policy is for SL communication between terminal devices over the PC5 interface. In the V2X scenario, it is more likely to describe the terminal device as an OBU or a vehicle equipped with an OBU (or with communication capabilities in other manners); however, it may alternatively be other types of terminal devices described above. The V2X communication policy may include at least one of service control information, communication assistance information, and transmission control information. Additionally, the V2X communication policy may include at least one of area identification information for identifying the specific area, a policy identifier for identifying the V2X communication policy, and a device identifier for identifying the electronic device 400A.

In an embodiment, the transceiver unit 404A may be configured to transmit a V2X communication policy such that one or more terminal devices can obtain the V2X communication policy. The transceiver unit 404A may be further configured to control or perform operations related to transmission and reception of signaling or messages.

In embodiments, the electronic device 400A may be implemented at the chip level, or may be implemented at the device level by including other external components (such as wired or wireless links). The electronic device 400A can work as a communication device as a whole machine, such as a base station, a roadside sub-system (such as RSU), a V2X application server, a central sub-system, or other network devices with management functions.

FIG. 4B illustrates an example electronic device capable of implementing a terminal device according to an embodiment of the present disclosure. The electronic device 400B may include various units to implement embodiments for configuring V2X communication on the terminal device side according to the present disclosure. In the example of FIG. 4B, the electronic device 400B includes a V2X communication control unit 402B and a transceiver unit 404B. Operations described below in conjunction with the terminal device may be implemented by the units 402B and 404B or other possible units of the electronic device 400B.

In an embodiment, the transceiver unit 404B may be configured to receive one or more V2X communication policies. The one or more V2X communication policies may be V2X communication policies used for respective areas. In an embodiment, the V2X communication policy is for SL communication between terminal devices over the PC5 interface. The transceiver unit 404B may be further configured to control or perform operations related to transmission and reception of signaling or messages.

In an embodiment, the V2X communication control unit 402B may be configured to determine, based on a location of the electronic device 400B itself, a first V2X communication policy corresponding to the location of the electronic device 400B from the one or more V2X communication policies, and apply the first V2X communication policy. The first V2X communication policy may include at least one of service control information, communication assistance information, and transmission control information. Additionally, the V2X communication policy may include an area identifier, a policy identifier, and/or a device identifier. A specific area corresponding to the V2X communication policy may be identified by an area identifier, a corresponding V2X communication policy may be identified by a policy identifier, and a corresponding control device, such as the electronic device 400A, may be identified by a device identifier.

In embodiments, the electronic device 400B may be implemented at the chip level, or may be implemented at the device level by including other external components (such as radio links or antennas). The electronic device 400B can work as a communication device as a whole machine, for example, terminal devices such as UE, an OBU, or a vehicle configured with communication capabilities.

FIG. 4C illustrates an example electronic device for frequency allocation according to an embodiment of the present disclosure. The electronic device 400C may include various units to implement various embodiments for allocating transmission resources based on characteristics of a Reconfigurable Intelligent Surface (RIS) device according to the present disclosure. In the example in FIG. 4C, the electronic device 400C includes a resource allocation unit 402C and a transceiver unit 404C.

In an embodiment, the resource allocation unit 402C may be configured to: based on a resonance frequency of an electromagnetic unit of the RIS device, determine a resource for transmission from the first terminal device to the RIS device. As an example, the transmission resource may be related to a frequency and may have different granularities. Specifically, the transmission resource may correspond to a band, a frequency, a carrier, a bandwidth part (BWP), or the like. In an embodiment, a frequency of the transmission resource is different from the resonance frequency of the electromagnetic unit of the RIS device to avoid the transmission from the first terminal device to the RIS device from being absorbed due to resonance with the electromagnetic unit of the RIS device. In an embodiment, a frequency as far away from the resonant frequency as possible can be selected from a plurality of selectable frequencies. When there are a plurality of RIS devices, a frequency that avoids multiple resonance frequencies of the electromagnetic units of these RIS devices can be selected from the plurality of selectable frequencies.

In an embodiment, the transceiver unit 404C may be configured to indicate resource information to the terminal device (such as the electronic device 400B), such that the terminal device performs transmission to the RIS device using the allocated resource, thereby avoiding or at least reducing absorption of transmission from the terminal device by the RIS device. The transceiver unit 404C may be further configured to control or perform operations related to transmission and reception of signaling or messages.

In embodiments, the electronic device 400C may be implemented at the chip level, or may be implemented at the device level by including other external components (such as wired or wireless links). The electronic device 400C can work as a communication device as a whole machine, such as a base station or a core network function entity (such as a PCF or an AMF).

It should be understood that the above various units are only logical modules divided based on logical functions to be implemented by the units, and are not intended to limit specific implementations, for example, the units may be implemented by software, hardware, or a combination of software and hardware. In actual implementation, the above various units may be implemented as independent physical entities, or may be implemented by a single entity (for example, a processor (CPU, DSP, or the like), or an integrated circuit). The processing circuitry may refer to various implementations of a digital circuitry, an analog circuitry, or a mixed signal (combination of analog and digital) circuitry that perform functions in a computing system. The processing circuitry can include, for example, a circuit such as an integrated circuit (IC), an application specific integrated circuit (ASIC), a portion or circuit of a separate processor core, the entire processor core, a separate processor, a programmable hardware device such as a field programmable gate array (FPGA), and/or a system including multiple processors.

### V2X Communication Policy

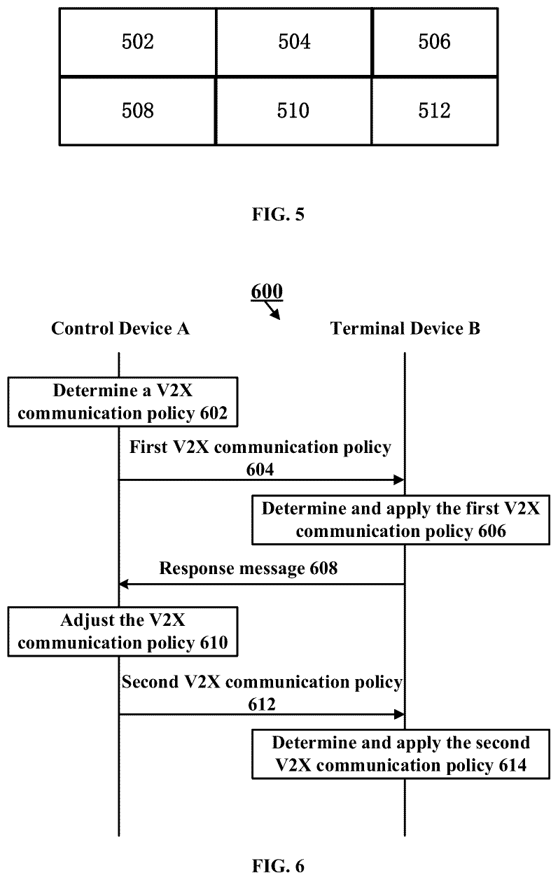

FIG. 5 illustrates an example V2X communication policy according to an embodiment of the present disclosure. In an embodiment, the V2X communication policy may include at least one of service control information, communication assistance information, and transmission control information. In an embodiment, the V2X communication policy may be for SL communication between terminal devices over the PC5 interface.

As shown in FIG. 5, service control information is included in a field 502. The service control information may be used to indicate at least one of an allowed service, a prioritized service and a restricted service in the specific area. The V2X service generally includes the following three types. Based on the communication status information, road environment information or road traffic information associated with a specific area, different specific services can be determined as allowed services, prioritized services or restricted services within the specific area.

1) Traffic active safety service, including: front tunnel alert, in-tunnel situation alert, lane convergence collision warning, road construction area alert, emergency parking belt position alert, dangerous goods transportation vehicle alert, front vehicle failure alert, special vehicle alert, surrounding emergency vehicle alert, rear vehicle passing alert, side vehicle collision alert, road ahead obstacle alert, road section speed limit alert, vehicle speeding alert, congestion alert, road hazard warning, lane change warning, forward collision warning, front vehicle emergency braking warning, vehicle close-range hazard warning, violation vehicle alert, extreme weather warning, mass fog monitoring, visibility monitoring and early warning, road icing monitoring and early warning, rock falling/throwing monitoring and early warning, pedestrian and animal intrusion monitoring, dynamic drivable area monitoring, barrier distance alert, driver status evaluation and early warning, over-the-horizon video perception, variable speed limit control, dynamic induction and detour, temporary shoulder use, and the like.

2) Traffic efficiency service, including: truck formation driving, emergency lane active control, ramp intelligent control, continuous harbor parking belt, construction road section traffic organization, and the like.

3) Information service, including: traditional infotainment service, 5G-based infotainment service, macro traffic operation status information service, micro traffic operation status information service, and the like.

Communication assistance information is included in a field 504. The communication assistance information may be used to indicate at least one of an assistance device and an unreliable area in the specific area. In the present disclosure, the unreliable area may be a sub-area within the specific area, and the terminal device in the sub-area has communication quality being lower than a specific threshold or cannot perform reliable transmission in the sub-area. In an embodiment, a first sub-area of the specific area may be defined as an unreliable area, based on the QoS of one or more terminal devices in the first sub-area being lower than a threshold. In an embodiment, a second sub-area of the specific area may be defined as an unreliable area, based on presence of an obstruction affecting transmission in the second sub-area or presence of an object that interferes with the electromagnetic environment in the second sub-area. For example, the obstruction may be walls, dense trees, large vehicles, or other objects that block transmission. In an embodiment, a third sub-area of the specific area may be defined as an unreliable area, based on historical QoS information in the third sub-area.

In the present disclosure, the assistance transmission may include any form of communication that serves as an assistance transmission for the communication of the terminal devices in the unreliable area. The assistance devices include, but are not limited to, communication devices that reflect or relay signals. For example, the assistance device may be a RIS device that reflects a signal, or various types of relay node devices. The control device can be connected to or sense the assistance device, or can receive information about the assistance device. Accordingly, the control device can issue the obtained the information about the assistance device as part of the V2X communication policy. This allows the terminal device located in an unreliable area to request a specific assistance device to provide an assistance transmission service.

Transmit control information is included in a field 506. The transmission control information may be used to indicate at least one of transmittable message versions, limits on packet extension content, transmission intervals, a packet size and transmission redundancy in the specific area. The items listed above can reflect, to some extent, the utilization level of communication resources (such as SL resources) by the transmission. For example, different amounts of resources are used for transmission of messages of different versions or messages with different extension content. Smaller transmission intervals, larger packets, and higher transmission redundancy mean more communication resources being used.

Optionally, an area identifier is included in a field 508. The area identifier can be used to identify a specific area to which the V2X communication policy is applicable. In an embodiment, the area identifier enables the terminal device to obtain a specific area to which the V2X communication policy is applicable and to apply the V2X communication policy based on its location matching the specific area (for example, its location is within the specific area).

Optionally, a policy identifier is included in a field 510. The policy identifier can be used to identify different V2X communication policies. For example, a combination of specific service control information, communication assistance information, and transmission control information may correspond to a V2X communication policy. In this way, several V2X communication policies can be predefined and identified by respective policy identifiers. In an embodiment, in a case that several V2X communication policies between the control device and the terminal devices have been defined, a specific V2X communication policy can be indicated between the control device and the terminal device by using only a policy identifier.

Optionally, a device identifier is included in a field 512. The device identifier can be used to identify a control device that issues the V2X communication policy. Based on the device identifier, the terminal device can learn about information about the control device so as to perform communication with the control device (for example, transmitting an assistance transmission request to the control device).

In some embodiments, the communication status information may include at least one of communication resources status, a number of terminal devices, service types, and quality of service (QOS) associated with the specific area. Generally, the above sub-information for communication status may affect allowed services, prioritized services or restricted services in the specific area and may affect transmittable message versions, limits on packet extension content, transmission intervals, a packet size, or transmission redundancy in the specific area.

In some embodiments, the road environment information may include at least one of a road section type, road section status, and obstruction (or interference) information. Generally, the road section type or road section status may affect allowed services, prioritized services, or restricted services for the specific area. The obstruction (or interference) information may affect determining of an unreliable area.

In some embodiments, the road traffic information may include at least one of vehicle attributes, vehicle distribution, and traffic status. Generally, the vehicle attributes (such as a vehicle body size) and vehicle distribution may affect determining of an unreliable area. The traffic status may affect allowed services, prioritized services, or restricted services for the specific area.

The following describes specific examples of determining V2X communication policies in different scenarios.

Example 1: When an intersection is in a congested state, for services at the intersection, safety or efficiency services need to be prioritized, for example, collaborative intersection traffic or collaborative ramp merging. In an embodiment, the road traffic information can be captured by sensors of the RSUs, or the road traffic information can be statistically analyzed based on received V2X messages. When air interface resources are limited (for example, when time and frequency resources available for allocation by the base station are limited and the RSUs detect that QoS of a large amount of communication cannot be guaranteed), other services can be restricted to some extent. Other services are, for example, information service, high-level autonomous driving service, or sensor data sharing corresponding to high-level autonomous driving. Correspondingly, use of these services in the area can be limited, or transmission parameters of these services (such as how frequently packets are transmitted or packet sizes) can be limited. For an example of the corresponding V2X communication policy, refer to items 1 and 2 of the following table 1.

Example 2: When non-motorized vehicles (presence of a plurality of non-motorized vehicles, non-motorized vehicles being driving fast, and presence of pedestrians) appear at the intersection of a non-motorized lane and a motorized lane/the intersection of motorized vehicle parking area (related information can also be captured by the RSUs through various measures), for services in this traffic scenario, safety services such as safe passage of vulnerable road users and sensing data sharing need to be prioritized; and in a case of insufficient air interface resources, transmission of other services (such as station path guidance service) is restricted, or extension content of the part of service is restricted (extension of an extension field in a packet corresponding to the part of service is prohibited). For an example of the corresponding V2X communication policy, refer to items 3 and 4 of the following table 1.

Example 3: When a road section is undergoing road maintenance and there is fence blocking, or when there are a large number of dense trees in the central green belt of the road, or when it is blocked by large vehicles or other objects, the control device such as an RSU, a base station, or other network devices may determine an area corresponding to the road section as an unreliable area based on nearby sensor information or QoS record data of terminal devices passing through the area. For an example of the corresponding V2X communication policy, refer to item 5 of the following table 1.

It should be noted that boxes left blank in table 1 represent unrestricted. Table 1 lists only five V2X communication policies in specific scenarios. In other scenarios, a V2X communication policy for a specific area can be determined based on the communication status information, road environment information, or road traffic information associated with the specific area.

TABLE 1
V2X communication policy

| | | | | V2X communication policy | | |
|---|---|---|---|---|---|---|
| | Channel | Road | Road | Service | Communication | Transmission |
| | status | environment | traffic | control | assistance | control |
| | information | information | information | information | information | information |
| 1 | Available | Intersection | Congestion | Prioritized | — | — |
| | resources | | | services: | | |
| | for SL are | | | traffic | | |
| | higher than | | | active | | |
| | a threshold. | | | safety | | |
| | Available | | | service, | | |
| | resources | | | traffic | | |
| | for SL are | | | efficiency | | |
| | lower than | | | service | | |
| | a threshold; | | | (allowed | | |
| | or QoS is | | | service: | | |
| | lower than | | | information | | |
| | a threshold. | | | service) | | |
| 2 | | Intersection | Congestion | Prioritized | — | Reduce a |
| | | | | services: | | packet size; |
| | | | | traffic | | reduce |
| | | | | active | | frequency |
| | | | | safety | | for |
| | | | | service, | | transmitting |
| | | | | traffic | | packets |
| | | | | efficiency | | |
| | | | | service | | |
| | | | | (restricted | | |
| | | | | service: | | |
| | | | | information | | |
| | | | | service) | | |
| 3 | Available | Intersection of a | Presence of | Prioritized | — | — |
| | resources | non-motorized | a plurality | services: | | |
| | for SL are | lane and a | of non- | safe | | |
| | higher than | motorized | motorized | passage of | | |
| | a threshold. | lane/Intersection | vehicles, | vulnerable | | |
| | | of motorized | non- | road users, | | |
| | | vehicle parking | motorized | sensing | | |
| | | areas | vehicles | data | | |
| | | | being | sharing, | | |
| | | | driving | and other | | |
| | | | fast, and | safety | | |
| | | | presence of | services. | | |
| | | | pedestrians | | | |
| 4 | Available | Intersection of a | Presence of | Prioritized | — | Prohibit an |
| | resources | non-motorized | a plurality | services: | | extension |
| | for SL are | lane and a | of non- | safe | | field in a |
| | lower than | motorized | motorized | passage of | | packet for |
| | a threshold; | lane/Intersection | vehicles, | vulnerable | | part of |
| | or QoS is | of motorized | non- | road users, | | services |
| | lower than | vehicle parking | motorized | sensing | | |
| | a threshold. | areas | vehicles | data | | |
| | | | being | sharing, | | |
| | | | driving | and other | | |
| | | | fast, and | safety | | |
| | | | presence of | services. | | |
| | | | pedestrians | Restricted | | |
| | | | | service: | | |
| | | | | path | | |
| | | | | guidance | | |
| | | | | service. | | |
| 5 | — | Obstruction | — | — | An unreliable | |
| | | | | | area, an | |
| | | | | | assistance | |
| | | | | | device | |

FIG. 6 illustrates an example signaling flow 600 for determining a V2X communication policy according to an embodiment of the present disclosure. The signaling flow 600 can be performed between one or more control devices (such as the electronic device 400A) and one or more terminal devices (such as the electronic device 400B).

As shown in FIG. 6, at 602, the control device A determines a V2X communication policy for a specific area based on at least one of communication status information, road environment information, and road traffic information associated with the specific area. The V2X communication policy may include at least one of service control information, communication assistance information, and transmission control information.

At 604, the control device transmits the first V2X communication policy. Correspondingly, the terminal device B can obtain the first V2X communication policy. At 606, the terminal device B determines, based on its own location, that the terminal device B is located within an area corresponding to the first V2X communication policy (that is, the first V2X communication policy is a V2X communication policy corresponding to its own location), and correspondingly applies the first V2X communication policy. In an embodiment, the terminal device B can obtain its own location information (such as coordinates), for example, through a global positioning system (GPS), and determine, based on area information carried in the first V2X communication policy, that the terminal device B is located within the area corresponding to the first V2X communication policy.

In some embodiments, the terminal device B can determine a type of service to be executed, based on at least one of an allowed service, a prioritized service, and a restricted service indicated by the service control information; transmit an assistance transmission request based on at least one of an unreliable area or an assistance device indicated by the communication assistance information; and/or based on the transmission control information, determine at least one of transmittable message versions, limits on packet extension content, transmission intervals, a packet size, and transmission redundancy. As an example, the terminal device B can adjust a priority of a corresponding QoS flow or QoS rule based on at least one of allowed service, prioritized service, and restricted service indicated by the service control information. For example, a priority of a QoS flow mapped to a prioritized service may be increased, or a corresponding PC5 QoS indicator (PQI) value is adjusted to increase a delay requirement. A priority of a QoS flow mapped to another service may be decreased, or a corresponding PQI value is adjusted to decrease a delay requirement. As an example, the terminal device B may indicate to the application layer a currently executable service, based on at least one of allowed service, prioritized service, and restricted service indicated by the service control information. Correspondingly, the application layer can delete QoS flows corresponding to restricted services. Additionally or alternatively, the terminal device B can start a timer to reject data transmission requests for restricted services before the timer expires.

At 608, optionally, after receiving or applying the first V2X communication policy, the terminal device B can transmit a response message to the control device A. For example, the response message may include information such as a current location of the terminal device A, a planned route, an expected speed, and a V2X service. The control device A can then adjust the V2X communication policy based on the response information.

At 610, the control device A may adjust the V2X communication policy for the specific area based on update of at least one of the communication status information, road environment information, and road traffic information associated with the specific area. The adjustment may be made to at least one of the service control information, communication assistance information, and transmission control information.

At 612, the control device A transmits a second V2X communication policy obtained through adjustment. Correspondingly, the terminal device B can obtain the second V2X communication policy. At 614, the terminal device B determines, based on its own location, that the terminal device B is located within an area corresponding to the second V2X communication policy (that is, the second V2X communication policy is a V2X communication policy corresponding to its own location), and correspondingly applies the second V2X communication policy.

It should be noted that through the signaling flow 600, the control device A can enable one or more terminal devices within a specific area and outside the specific area to obtain a V2X communication policy for the specific area. Similarly, the terminal device B can obtain a corresponding V2X communication policy for one or more areas.

In some embodiments, the control device A may be a base station, a roadside sub-system (such as an RSU), a V2X application server, a central sub-system, or other network devices with management functions. The terminal device B may be a UE, an OBU, or a vehicle configured with communication capabilities. The terminal device B can perform SL communication over the PC5 interface in the specific area based on the applied V2X communication policy. Because generation of the V2X communication policy takes into account the communication status information, road environment information or road traffic information associated with the specific area, the terminal device B can perform services or use transmission parameters matching a current status in the specific area; and can even request an assistance transmission service based on information about an unreliable area. This greatly improves stability and coverage performance of SL communication.

### Assistance Transmission

In the present disclosure, the terminal device located in an unreliable area has quality of communication or quality of service being lower than a specific threshold or even cannot perform reliable transmission. The unreliable area may occur due to factors such as obstruction, excessive propagation loss, or presence of electromagnetic interference. Assistance transmission is expected to allow the terminal device to perform reliable transmission before leaving the unreliable area. The assistance transmission may include any form of communication that serves as an assistance transmission for communication of the terminal device in the unreliable area, including but not limited to reflection or relay transmission of signals.

The RIS device may be used for reflective transmission, as described specifically below. Relay transmission may include L1 (layer 1) relay, L2 (layer 2) relay, and L3 (layer 3) relay. For L1 relay, a relay node may perform a layer 1 function (such as physical layer function). For example, the relay node may perform the layer 1 function in the communication between a source node and a target node. For L2 relay, the relay node may perform a layer 1 function and a layer 2 function (such as a media access control layer or radio link control layer function). For example, the relay node may perform the layer 1 function and layer 2 function in the communication between the source node and the target node. For L3 relay, the relay node may perform a layer 1 function, a layer 2 function, and a layer 3 function (such as a packet data aggregation protocol layer function or an Internet protocol layer function). For example, the relay node may perform the layer 1 function, the layer 2 function, and the layer 3 function in the communication between the source node and the target node.

In the present disclosure, assistance device information may be used to indicate at least one of device types, locations, and coverage of one or more assistance devices. For example, the device type may be used to indicate whether the assistance device (that is, a device providing the assistance transmission) is a relay node providing the relay transmission or a RIS device transmitting signals through reflection. The device type may even be used to indicate whether the relay node is for L1, L2, or L3 relay and whether the RIS device has capabilities of signaling transmission, reception, and processing. For example, the location may be used to enable the terminal device to determine a relative distance between an assistance device and the terminal device, and to further determine whether the assistance device can be used for assistance transmission. For example, the coverage may be used to enable the terminal device to determine whether the terminal device and the target node are located within a serving range of the assistance device, and to further determine whether the assistance device can be used for assistance transmission. In an example, the coverage may be a circular coverage centered on the assistance device itself, as represented by a distance parameter (such as a radius). To be more fine-grained, the coverage may alternatively be expressed as a coverage of the assistance device in each direction (for example, each direction may correspond to a specific radian range and each radian range may correspond to one distance value parameter).

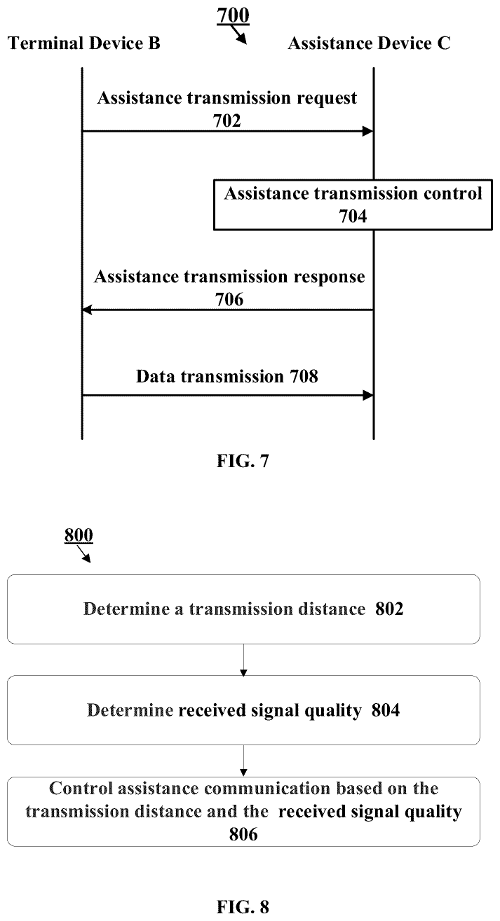

FIG. 7 illustrates an example signaling flow 700 for establishing assistance transmission according to an embodiment of the present disclosure. In the example in FIG. 7, the terminal device B directly requests the assistance device C for an assistance transmission service. Correspondingly, the assistance device C needs to have a capability of signaling processing to perform a signaling flow with the terminal device B. In an embodiment, the control device A may act as an assistance device C. In another embodiment, the RIS device with a capability of signaling processing may act as an assistance device C.

As shown in FIG. 7, at 702, the terminal device B transmits an assistance transmission request to the assistance device C. The assistance transmission request may include, for example, one or more of the following information: information about the terminal device, such as a current location, planned route, and expected speed; information about a target node, such as an area and a current location where a target node D is located; assistance transmission service information, such as a priority and a marking manner for assistance transmission packets; and a propagation type, such as unicast, groupcast, or broadcast. In some embodiments, the assistance transmission may be a relay transmission. Correspondingly, the relay service information may include a priority of the relay and a marking manner for packets. The marking manner for assistance transmission packets can be used to indicate how the terminal device B is to mark packets that require assistance transmission of the assistance device C.

At 704, upon reception of the assistance transmission request, the assistance device C performs assistance transmission control based on the assistance transmission request and its own characteristics. In an embodiment, based on its own location and the current location of the terminal device B, the assistance device C may determine whether the terminal device B is located within its own coverage and whether the assistance device C can provide an assistance transmission service for the terminal device B. In an embodiment, based on the planned route or expected speed of the terminal device B, the assistance device C may determine whether the terminal device B is to be located within its own coverage for a period of time and whether the assistance device C can provide an assistance transmission service for the terminal device B for a period of time. In an embodiment, based on the area or current location where the target node D (not shown in the figure) is located, the assistance device C may determine whether the target node D is located within its own coverage and whether the assistance device C can provide an assistance transmission service for the target node D. In an embodiment, in a case that the assistance device has limited transmission resources, it can provide service only for an assistance transmission request corresponding to a higher priority. In an embodiment, based on the propagation type (including unicast, groupcast, or broadcast), the assistance device C may determine whether to provide an assistance transmission service for the terminal device B. It should be noted that different propagation types may correspond to different target node requirements. For example, unicast may correspond to one specific coordinate area, groupcast may correspond to a plurality of adjacent coordinate areas, and broadcast needs to correspond to a plurality of directional or even omnidirectional areas.

At 706, the assistance device C transmits an assistance transmission response to the terminal device B. The assistance transmission response may indicate whether to provide an assistance transmission service for the terminal device B. Alternatively, the assistance transmission response may indicate direction information used for transmission from the terminal device B to the assistance device C. The direction information can indicate a direction of a transmit beam from the terminal device B to the assistance device C. In an embodiment, the direction of the transmit beam is determined by the assistance device C based on its own location and the location of the terminal device B. For example, the assistance device C can provide directions of one or more candidate transmit beams to the terminal device B to reduce a time for scanning a corresponding beam by the terminal device B.

In a case that the assistance transmission response indicates providing an assistance transmission service for the terminal device B, at 708, the terminal device B transmits a packet to the assistance device C and the assistance device C transmits it to the target node D. It should be understood that assistance transmission to a plurality of target nodes may be performed in a case that the assistance transmission is groupcast or broadcast.

Regardless of unicast, groupcast, or broadcast, it is desired that the assistance device provides assistance transmission while saving its transmission resources. For groupcast or broadcast, the effect of transmission resources saving by avoiding unnecessary assistance transmissions is more obvious. As described above, the marking manner for assistance transmission packets can be used to indicate how the terminal device B is to mark packets that require assistance transmission of the assistance device C. The assistance device C needs to perform assistance transmission only for a packet with a specific identifier. For example, the packet may be identified by a source layer-2 ID, or may be identified by a specific mark in a header of another transport protocol layer (such as PHY/MAC/SDAP). In an embodiment, based on how the assistance transmission packet is marked, the assistance device C may determine whether to perform assistance transmission of a particular packet. In an embodiment, the assistance device C may directly forward a packet coming from the terminal device B, or may parse a plurality of packets and reconstruct a packet to be forwarded. For example, the assistance device C may parse out duplicate information or unwanted information based on specific criteria from a plurality of packets, so that a reconstructed packet does not include such information (for example, in a manner of clipping a specific field of the packet). This further saves resources for assistance transmission.

FIG. 8 illustrates example processing 800 for controlling assistance transmission based on a transmission distance according to an embodiment of the present disclosure. The following describes the processing 800 still with reference to the terminal device B and the assistance device C.

As shown in FIG. 8, at 802, upon receiving an assistance transmission request from the terminal device B, the assistance device C may determine a transmission distance from the assistance device C to the target node D. For example, the assistance transmission request may include an area or a current location where the target node D is located. The assistance device C may determine the transmission distance based on its own location and the location of the target node D. In the assistance transmission, the transmission distance corresponds to a (remaining) distance over which a signal is to be transmitted from the assistance device C to the target node D after the assistance device C receives the signal from the terminal device B.

At 804, the assistance device C may determine signal quality of transmission from the terminal device B. For example, the signal quality may be characterized by an indicator such as reference signal received power (RSRP), reference signal received quality (RSRQ), or received signal strength indication (RSSI).

At 806, when the signal quality is insufficient to support effective transmission over the transmission distance, it is determined that the assistance device C is to provide assistance transmission for the terminal device B. When the signal quality is sufficient to support effective transmission over the transmission distance, it is determined that the assistance device C is not to provide assistance transmission for the terminal device B. In an embodiment, the assistance device C may equate the received signal quality to transmission signal quality from the assistance device C to the target node D, and determine, based on the current transmission environment, whether the equivalent transmission signal quality is sufficient to ensure that the signal can be still reliably received by the target node D after passing through the transmission distance.

In some embodiments, similarly, the terminal device B may determine, based on the transmission distance to target node D, whether an assistance transmission is required. For example, if the transmission signal quality is insufficient to support effective transmission over the transmission distance, the terminal device B may request the assistance device C for an assistance transmission service. In V2X scenarios, both the terminal device B and the target node D may be in motion, making a channel status between the two unstable (for example, obstruction may occur between the two during a specific time period). Therefore, the determining made by the terminal device B may be inaccurate. Even if the terminal device B determines effective transmission to the target node D can be supported, obstruction makes the opposite happen. Because the assistance device C is normally stationary, a channel status between the assistance device C and the target node D is relatively stable. As a result, the determining made by the assistance device C as to whether to provide an assistance transmission is generally more accurate.

It should be noted that the assistance device C may store a correspondence between transmission signal qualities and transmission distances. Such correspondence may be obtained through numerical calculations or scene simulations, or through historical data statistics. Such correspondence may be reflected by continuous curves or discrete values. Table 2 below is a table where the correspondence is stored (values are examples only). Table 3 below shows examples of operations 804 and 806 based on table 2.

TABLE 2
Correspondence between transmission signal
quality and transmission distances

| | Effective transmission |
|---|---|
| Signal quality (dB) | distance (meters) |
| 3 | 100 |
| 4 | 200 |
| 5 | 300 |

TABLE 3
Example operations

| Equivalent | | | | Assistance | |
|---|---|---|---|---|---|
| transmission | | | | transmission | |
| signal | | Transmission | | required | |
| quality | | distance | | or not | Notes |
| 4 | dB | ≤200 | m | No | Current transmission |
| | | | | | of the terminal device |
| | | | | | B can reach the target |
| | | | | | node D, not requiring |
| | | | | | assistance |
| | | | | | transmission. |
| 4 | dB | >200 | m | Yes | Current transmission |
| | | | | | of the terminal device |
| | | | | | B cannot reach the |
| | | | | | target node D, and |
| | | | | | requires assistance |
| | | | | | transmission. |
| 3.5 | dB | >100 | m | Yes | In order to ensure |
| | | | | | effective transmission, |
| | | | | | 3.5 dB is fitted down |
| | | | | | to 3 dB and |
| | | | | | determination is made |
| | | | | | accordingly. |

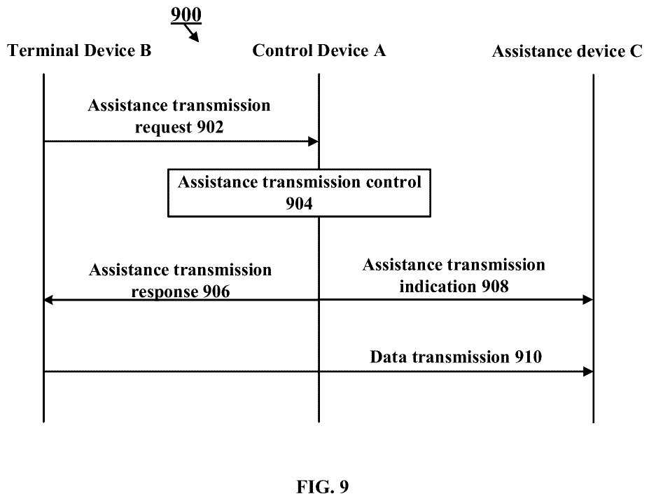

FIG. 9 illustrates an example signaling flow 900 for establishing assistance transmission according to an embodiment of the present disclosure. In the example in FIG. 9, the terminal device B requests the control device A for an assistance transmission service, and the control device A indicates the assistance device C to provide an assistance transmission service for the terminal device B. Correspondingly, the assistance device C may have no signaling processing capability, and the control device A performs a signaling flow with the terminal device B. In an embodiment, the RIS device may act as an assistance device C.

As shown in FIG. 9, at 902, the terminal device B transmits an assistance transmission request to the control device A. The assistance transmission request may include, for example, one or more of the following information: information about the terminal device, such as a current location, planned route, and expected speed; information about a target node, such as an area and a current location where a target node D is located; assistance transmission service information, such as a priority and a marking manner for assistance transmission packets; and a propagation type, such as unicast, groupcast, or broadcast. In some embodiments, the assistance transmission may be a relay transmission. Correspondingly, the relay service information may include a priority of the relay and a marking manner for packets. The marking manner for assistance transmission packets can be used to indicate how the terminal device B is to mark packets that require assistance transmission of the assistance device C.

At 904, upon reception of the assistance transmission request, the control device A performs assistance transmission control based on the assistance transmission request and assistance device information. The assistance device information may be used to indicate at least one of a device type, location, and coverage of an assistance device controlled by the control device A. In an embodiment, based on the current location of the terminal device B and the current location of the assistance device C, the control device A may determine whether the terminal device B is located within coverage of the assistance device C and whether the assistance device C can provide an assistance transmission service for the terminal device B. In an embodiment, based on the planned route or expected speed of the terminal device B, the control device A may determine whether the terminal device B is to be located within coverage of the assistance device C for a period of time and whether the assistance device C can provide an assistance transmission service for the terminal device B for a period of time. In an embodiment, based on the area or current location where the target node D (not shown in the figure) is located, the control device A may determine whether the target node D is located within coverage of the assistance device C and whether the assistance device C can provide an assistance transmission service for the target node D. In an embodiment, in a case that the assistance device has limited transmission resources, it can provide service only for an assistance transmission request corresponding to a higher priority. In an embodiment, based on the propagation type (including unicast, groupcast, or broadcast), the control device A may determine whether to provide an assistance transmission service for the terminal device B.

At 906 and 908, the control device A transmits an assistance transmission response and an assistance transmission indication to the terminal device B and the assistance device C, respectively. The assistance transmission response may indicate whether the assistance device C is to provide an assistance transmission service for the terminal device B. Additionally, the assistance transmission response may indicate direction information used for transmission from the terminal device B to the assistance device C. The direction information indicates a direction of a transmit beam from the terminal device B to the assistance device C. In an embodiment, the direction of the transmit beam is determined by the control device A based on the locations of the assistance device C and the terminal device B. For example, the control device A may provide directions of candidate transmit beams to the terminal device B to reduce a time for scanning a corresponding beam by the terminal device B. The assistance transmission indication may be used to make configuration for the assistance device C, to enable the assistance device to prepare to provide assistance transmission to the target node D for the terminal device B. Alternatively, the assistance transmission indication may indicate direction information used for transmission from the assistance device C to the target node D. For example, the control device A may provide directions of candidate transmit beams to the assistance device C to reduce a time for scanning a corresponding beam by the assistance device C.

In a case that the assistance transmission response indicates providing an assistance transmission service for the terminal device B, at 910, the terminal device B transmits data to the assistance device C and the assistance device C transmits it to the target node D. It should be understood that assistance transmission to a plurality of target nodes may be performed in a case that the assistance transmission is groupcast or broadcast.

### Communication Using RIS Devices

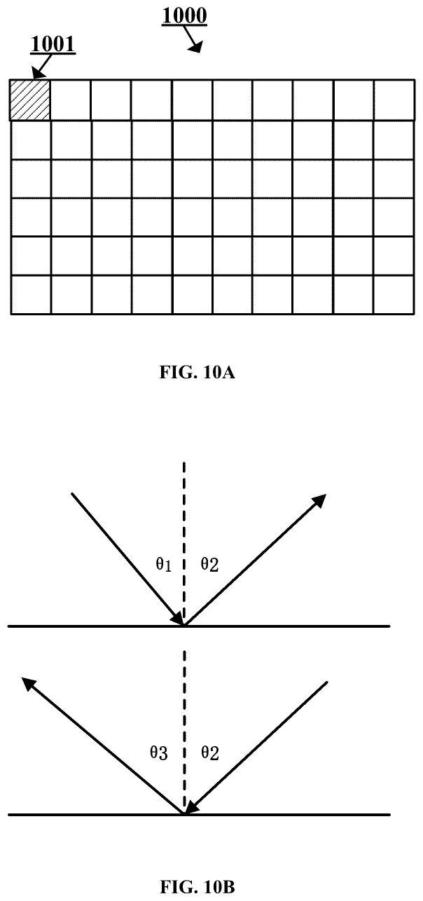

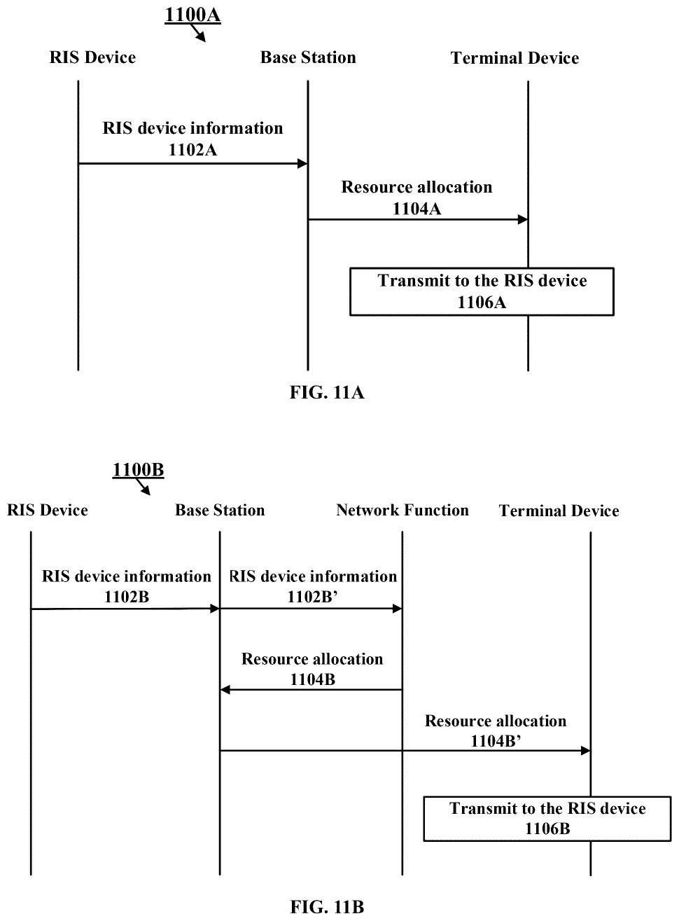

FIG. 10A illustrates an example RIS device according to an embodiment of the present disclosure. The RIS can also be referred to as intelligent reflective surface (IRS). In the present disclosure, the RIS may act as an assistance device, for example, to perform reflective transmission for communication from the terminal device.

The RIS is an artificial electromagnetic surface structure with real-time programmable electromagnetic characteristics and is an artificial two-dimensional material with a subwavelength size. The RIS is typically made of metal, media, and adjustable components and may be equivalently expressed as an RLC circuit. As shown in FIG. 10A, the RIS device 1000 may be formed by a plurality of electromagnetic units (unit cell) arranged in a two-dimensional structure, and each electromagnetic unit (such as 1001) may be expressed as an RLC circuit. As shown in FIG. 10A, the electromagnetic units are tightly arranged to implement approximately continuous aperture. Physical properties of the electromagnetic unit, such as capacitance, resistance, or inductance, can be adjusted to change radiation properties of the RIS, implementing unconventional physical phenomena (such as irregular reflection, negative refraction, absorption, focus, and polarization conversion). For example, one or more electromagnetic units can be adjusted through software programming so as to dynamically adjust electromagnetic waves (for example, to implement different transmission gains).

The RIS implements passive control of electromagnetic waves by adjusting the physical properties of the artificial electromagnetic materials. The adjustment of physical properties requires active implementation. Therefore, the RIS can be understood as quasi-passive. In addition, the RIS has a wide frequency response and can operate on bands such as acoustic spectrum, microwave spectrum, terahertz spectrum, or light spectrum.

In some embodiments, the RIS device 1000 may be coupled to one or more processors, and the one or more processors may be coupled to (wireless or wired) transceiver components and memories to form a RIS system. The processor and transceiver components work together to enable the RIS system to have signaling transmission, reception and processing functions (for example, functions similar to the terminal device). In this way, during the assistance transmission for other devices, the RIS system can process signaling with other devices, thus operating as the control device of the RIS device 1000 itself. In the present disclosure, the RIS system with signaling transmission, reception, and processing functions is also referred to as a RIS device when no confusion is caused with the naming.

In some embodiments, the RIS device can perform wireless communication with the terminal device or control device such as a base station. Correspondingly, the RIS device can be arranged in a relatively flexible manner, for example, through unmanned aerial vehicle mounting, vehicle mounting, or portable installation. In some embodiments, the RIS device can connect in a wired manner to the control device such as a base station and an RSU. The RIS device may be connected in a wired manner to enable other devices to learn about presence of the RIS device and device information, or may perform wireless communication (such as broadcast) to enable other devices to learn about presence of the RIS device and device information.

FIG. 10B illustrates an example of performing electromagnetic wave transmission by using the RIS. In a first transmission of FIG. 10B, a first electromagnetic wave is incident on the RIS device 1000 from the upper left at a first incident angle θ1, and exits the RIS device 1000 to the upper right at a first exit angle θ2. In a second transmission, a second electromagnetic wave is incident on the RIS device 1000 from the upper left at a second incident angle θ2 equal to the first exit angle, and exits the RIS device 1000 to the upper left at a second exit angle θ3.

Through adjustment of physical properties of the electromagnetic unit, in the first transmission of FIG. 10B, the exit angle and the incident angle may be not equal (for example, θ2≠θ1), that is, unconventional reflection may occur. Considering the two transmissions in FIG. 10B, there may be cases where the first incident angle is not equal to the second exit angle (for example, θ1≠θ3) or the two are not approximate, that is, angular reciprocity for the beam transmission path is not satisfied between the transmit party and the receive party. According to an implementation, transmission characteristics of the RIS device can be represented by the following example table 4. The control device may determine the coverage of the RIS device based on the transmission characteristics, for example, defining incident and exit ranges with gains being greater than a threshold as the coverage. It should be noted that in this example, only when the first incident angle is within a range of 1° to 10°, angular reciprocity for beam transmission and reception is then basically satisfied. This means that transmission of a first terminal device can reach a second terminal device after being reflected by the RIS device, and in the opposite direction, transmission of the second terminal device can also reach the first terminal device after being reflected by the RIS device. Therefore, the angular reciprocity is beneficial for transmission of services that require symmetric transmission between terminal devices. Correspondingly, in a case that the RIS device acts as an assistance device, the control device can use the angular reciprocity to assist transmission of symmetric services between the terminal devices.

TABLE 4
Transmission characteristics of the RIS device

| Incident | Exit | Gain |
|---|---|---|
| angle (°) | angle (°) | (dB) |
| 0-10 | 0-10 | 1.5 |
| 10-60 | 10-70 | 1 |
| 60-90 | 70-120 | 0.2 |

In some embodiments, to increase flexibility of the RIS device as an assistance device, settings of the RIS device can alternatively be dynamically adjusted in addition to being set statically. For example, the RIS device can move in location dynamically, or for example, rotate along the x, y, or z axis to provide omnidirectional panel adjustment freedom. In some embodiments, a plurality of RIS devices can be cascaded. Through adjustment of angles of cascaded RIS devices, a variety of transmission paths can be implemented and the coverage can be expanded.

As described with reference to FIG. 7 to FIG. 9, the RIS device can act as the assistance device C. The signaling flows in FIG. 7 to FIG. 9 are briefly described below by using the RIS device as the assistance device C.

In the example in FIG. 7, the terminal device B may request an assistance transmission service directly from the RIS device (with signaling transmission, reception and processing functions). In some embodiments, the terminal device B may learn information about a RIS device within a specific area based on the V2X communication policy of the control device, or may learn information about a nearby RIS device based on the broadcast of the RIS device itself. Specifically, at 702, for example, when in an unreliable area or with QoS becoming below the threshold, the terminal device B transmits an assistance transmission request to the RIS device. At 704, upon reception of the assistance transmission request, the RIS device performs assistance transmission control based on the assistance transmission request and its own characteristics. In an embodiment, based on the current location of the terminal device B, its own location, and freedom degree of adjustment, the RIS device may determine whether the terminal device B is located within its own coverage and whether the RIS device can provide an assistance transmission service for the terminal device B. In an embodiment, based on the planned route or expected speed of the terminal device B, the RIS device may determine whether the terminal device B is to be located within its own coverage for a period of time and whether the RIS device can provide an assistance transmission service for the terminal device B for a period of time. In an embodiment, based on the area or current location where the target node D is located, its own location, freedom degree of adjustment, or cascadability, the RIS device may determine whether the target node D is located within the coverage of the target node D or another cascaded RIS device, and whether the RIS device can provide an assistance transmission service for the target node D. In an embodiment, the RIS device can dynamically adjust itself (such as a rotation angle or gain level) based on the assistance transmission request, so as to provide assistance transmission for the terminal device B.

At 706, the RIS device transmits an assistance transmission response to the terminal device B. The assistance transmission response may indicate direction information used for transmission from the terminal device B to the RIS device. The direction information can indicate a direction of a transmit beam from the terminal device B to the RIS device. For example, the RIS device can provide directions of candidate transmit beams to the terminal device B to reduce a time for scanning a corresponding beam by the terminal device B.

In a case that the assistance transmission response indicates providing an assistance transmission service for the terminal device B, at 708, the terminal device B transmits data to the RIS device and the assistance device C transmits it to the target node D through reflection.

In the example in FIG. 9, the terminal device B may request an assistance transmission service from the control device A, and the RIS device (with or without signaling transmission, reception and processing functions) provides an assistance transmission service for the terminal device B. Specifically, at 902, the terminal device B transmits an assistance transmission request to the control device A. At 904, upon reception of the assistance transmission request, the control device A performs assistance transmission control based on the assistance transmission request and assistance device information. The assistance device information may be used to indicate at least one of a location and coverage of a RIS device controlled by the control device A. In an embodiment, based on the current location of the terminal device B and the current location of the RIS device, the control device A may determine whether the terminal device B is located within coverage of the RIS device and whether the RIS device can provide an assistance transmission service for the terminal device B. In an embodiment, based on the planned route or expected speed of the terminal device B, the control device A may determine whether the terminal device B is to be located within coverage of the RIS device for a period of time and whether the RIS device can provide an assistance transmission service for the terminal device B for a period of time. In an embodiment, based on the area or current location where the target node D is located, the control device A may determine whether the target node D is located within coverage of the RIS device and whether the RIS device can provide an assistance transmission service for the target node D. In the above determining operations, both the freedom of adjustment and cascadability for the RIS device can be considered.

At 906 and 908, the control device A transmits an assistance transmission response and an assistance transmission indication to the terminal device B and the RIS device, respectively. The assistance transmission response may indicate direction information used for transmission from the terminal device B to the RIS device. The direction information can indicate a direction of a transmit beam from the terminal device B to the RIS device. The assistance transmission indication may be used to make configuration for the RIS device, to enable the RIS device to prepare to provide assistance transmission to the target node D for the terminal device B. Additionally, the assistance transmission indication may indicate direction information used for transmission from the RIS device to the target node D. For example, the control device A can configure an adjustment angle of the RIS device, to make an exit direction point to the target node D or to a cascaded next RIS device.

In a case that the assistance transmission response indicates providing an assistance transmission service for the terminal device B, at 910, the terminal device B transmits data to the RIS device and the RIS device transmits it to the target node D.

In the present disclosure, it is realized that when the wavelength of an electromagnetic wave incident on the RIS device is close to the length of the electromagnetic unit of the RIS device in a direction of the variable capacitance, resistance, or inductance, the frequency of the incident electromagnetic wave may be close to the resonance frequency of the electromagnetic unit. In this case, the phase and amplitude of the reflection coefficient may be close to zero and the minimum value, respectively (that is, a resonance phenomenon occurs), and the energy of the incident electromagnetic wave will be absorbed. In other words, in order to make energy of the incident electromagnetic wave reflected by the RIS device as much as possible, it is desired for the frequency of the incident electromagnetic wave to be far away from the resonance frequency of the electromagnetic unit of the RIS device. Correspondingly, the length of the electromagnetic unit of the RIS device or its resonance frequency of the RIS device needs to be considered for allocating transmission resources for SL communication through the PC5 interface in order to avoid resonance phenomena.

FIG. 11A illustrates an example signaling flow 1100A for allocating a transmission resource for a PC5 interface according to an embodiment of the present disclosure. In the signaling flow 1100A, the transmission resource allocation is performed by a base station.

As shown in FIG. 11A, at 1102A, the RIS device transmits RIS device information to the base station. The RIS device information may include resonance frequency or size information of electromagnetic units. Additionally, the RIS device information may include at least one of the type, location, and coverage of the assistance device. In an embodiment, the base station may additionally or alternatively obtain information about one or more RIS devices from another device responsible for managing the RIS devices. At 1104A, the base station allocates a resource for transmission from the terminal device to the RIS device based on the resonance frequency or size information of the electromagnetic unit of the RIS device, and indicates the allocated resource to the terminal device. At 1106A, the terminal device uses the allocated transmission resource to communicate with the RIS device, where the transmission from the terminal device to the RIS device is performed through the PC5 interface. As an example, the transmission resource may be related to a frequency and has different granularities. Specifically, the transmission resource may correspond to a band, a frequency, a carrier, a BWP, or the like. It should be noted that the operation of the signaling flow 1100A may be performed in conjunction with the assistance transmission operations of the signaling flows 700 and 900, and details are not repeated herein.

FIG. 11B illustrates a signaling flow 1100B for allocating a transmission resource for a PC5 interface according to an embodiment of the present disclosure. In the signaling flow 1100B, the transmission resource allocation is performed by a core network function entity. The network function entity may include a PCF, an AMF, or a new network function entity developed in the future.

As shown in FIG. 11B, at 1102B, the RIS device transmits RIS device information to the base station. At 1102B′, the base station transmits the RIS device information to the network function entity in the core network. The RIS device information may include resonance frequency or size information of electromagnetic units. Additionally, the RIS device information may include at least one of the type, location, and coverage of the assistance device. In an embodiment, the base station or the network function entity may additionally or alternatively obtain information about one or more RIS devices from another device responsible for managing the RIS devices. At 1104B, the network function entity allocates a resource for transmission from the terminal device to the RIS device based on the resonance frequency or size information of the electromagnetic unit of the RIS device, and indicates an allocated resource to the terminal device through the base station. At 1104B′, the base station receives and indicates the allocated resource to the terminal. At 1106B, the terminal device uses the allocated resource to communicate with the RIS device, where the transmission from the terminal device to the RIS device is performed through the PC5 interface. As an example, the transmission resource may be related to a frequency and has different granularities. Specifically, the transmission resource may correspond to a band, a frequency, a carrier, a BWP, or the like. It should be noted that the operation of the signaling flow 1100B may be performed in conjunction with the assistance transmission operations of the signaling flows 700 and 900, and details are not repeated herein.

### Example Method

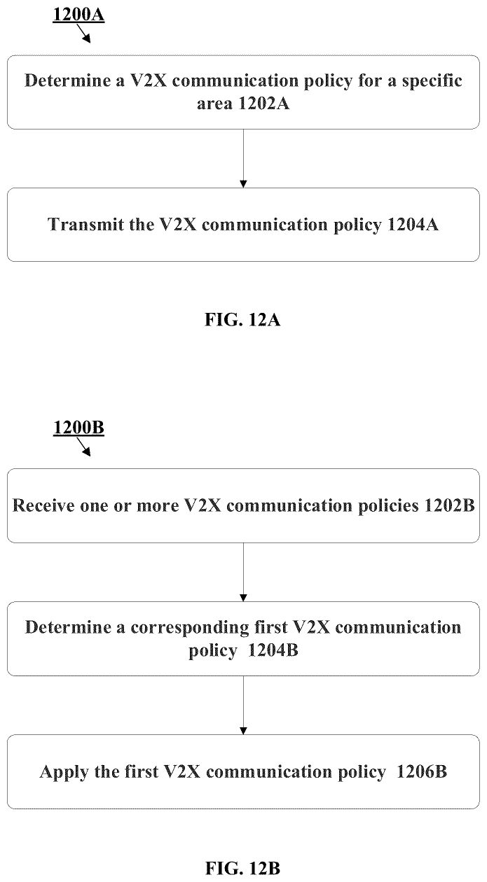

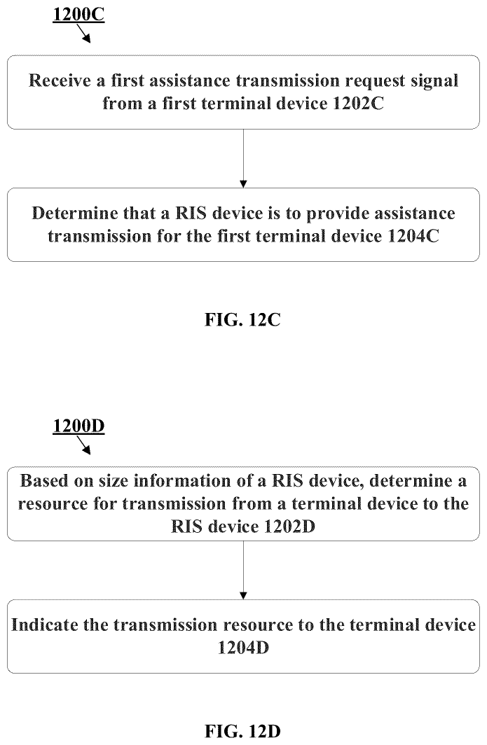

FIG. 12A illustrates a first example method for communication according to an embodiment of the present disclosure. This method may be performed by the electronic device 400A or a corresponding control device (such as a base station, a roadside sub-system, an application server, and a central sub-system). As shown in FIG. 12A, the method 1200A may include determining a V2X communication policy for a specific area, where the V2X communication policy includes at least one of service control information, communication assistance information, and transmission control information (block 1202A). The method may further include transmitting the V2X communication policy, enabling a first terminal device to obtain the V2X communication policy (block 1204A). Further details of the method may be understood with reference to the description above with respect to the electronic device 400A or the control device.

In an embodiment, the V2X communication policy is determined based on at least one of communication status information, road environment information, and road traffic information associated with the specific area. The communication status information includes at least one of communication resources status, a number of terminal devices, service types, and quality of service (QOS) associated with the specific area; the road environment information includes at least one of a road section type, road section status, and obstruction information; and/or the road traffic information includes at least one of vehicle attributes, vehicle distribution, and traffic status.

In an embodiment, the service control information is used to indicate at least one of an allowed service, a prioritized service and a restricted service in the specific area; the communication assistance information is used to indicate at least one of an assistance device and an unreliable area in the specific area; and/or the transmission control information is used to indicate at least one of transmittable message versions, limits on packet extension content, transmission intervals, a packet size and transmission redundancy in the specific area. The V2X communication policy further includes at least one of area identification information, a policy identifier, and a device identifier of the electronic device.

In an embodiment, the method 1200A may include: adjusting the V2X communication policy for the specific area, based on at least one of updated communication status information, updated road environment information, and updated road traffic information. The specific area corresponds to a block, a road section, an intersection, or a specific scene.

In an embodiment, the method 1200A may include: defining a first sub-area of the specific area as an unreliable area, based on QoS of one or more terminal devices in the first sub-area being lower than a threshold; defining a second sub-area of the specific area as an unreliable area, based on presence of an obstruction or interference source in the second sub-area; and/or defining a third sub-area of the specific area as an unreliable area, based on historical QoS information in the third sub-area.

In an embodiment, assistance device information is used to indicate at least one of a device type, location, and coverage of one or more assistance devices, where the device type includes a relay node or a Reconfigurable Intelligent Surface (RIS) device.

In an embodiment, the method 1200A may include: receiving an assistance transmission request from the first terminal device, the assistance transmission request indicating at least one of: a location, expected speed, or expected route of the first terminal device; information about a target node; or a V2X service type or priority; based on the assistance transmission request and the assistance device information, determining that a first assistance device is to provide assistance transmission for the first terminal device, where the first assistance device is a relay node or a RIS device; and transmitting a first message to the first terminal device and transmitting a second message to the first assistance device.

In an embodiment, the first message includes direction information for transmission from the electronic device to the first assistance device; and/or the second message includes direction information for transmission from the first assistance device to the target node.

In an embodiment, the method 1200A may include: receiving an assistance transmission request from the first terminal device, the assistance transmission request indicating at least one of: a location, expected speed, or expected route of the first terminal device; information about a target node; or a V2X service type or priority; based on the assistance transmission request, determining that the electronic device is to provide assistance transmission for the first terminal device; and transmitting a third message to the first terminal device.

In an embodiment, determining that the electronic device is to provide assistance transmission for the first terminal device includes: determining a transmission distance from the electronic device to the target node; determining signal quality of transmission from the first terminal device; and when the signal quality is insufficient to support effective transmission over the transmission distance, determining that the electronic device is to provide assistance transmission for the first terminal device.

In an embodiment, the electronic device is implemented as a base station, and the first assistance device is implemented as a RIS device; where the processing circuit is further configured to: based on a resonance frequency of an electromagnetic unit of the RIS device, determine a resource for transmission from the first terminal device to the RIS device; and indicate the frequency information to the first terminal device.

FIG. 12B illustrates a second example method for communication according to an embodiment of the present disclosure. The method may be performed by an electronic device 400B or a corresponding terminal device (such as an OBU, a vehicle, or UE). As shown in FIG. 12B, the method 1200B may include receiving one or more V2X communication policies, where the one or more V2X communication policies are used for respective areas (block 1202B). The method may further include based on its own location, determining a first V2X communication policy corresponding to its own location from the one or more V2X communication policies, where the first V2X communication policy includes at least one of service control information, communication assistance information, and transmission control information (block 1204B). The method may further include applying the first V2X communication policy (block 1206B). Further details of the method may be understood with reference to the description above with respect to the electronic device 400B or the terminal device.

In an embodiment, applying the first V2X communication policy includes: determining a type of service to be executed, based on at least one of an allowed service, a prioritized service, and a restricted service indicated by the service control information; transmitting an assistance transmission request based on at least one of an unreliable area or an assistance device indicated by the communication assistance information; and/or based on the transmission control information, determining at least one of transmittable message versions, limits on packet extension content, transmission intervals, a packet size, and transmission redundancy.

In an embodiment, transmitting the assistance transmission request includes: transmitting the assistance transmission request to a control device, the assistance transmission request indicating at least one of: a location, expected speed or expected route of a first terminal device; information about a target node; or a V2X service type or priority; and receiving a first message from the control device, the first message indicating that a first assistance device or the control device is to provide assistance transmission for the electronic device.

In an embodiment, transmitting the assistance transmission request to the first assistance device, the assistance transmission request indicating at least one of: a location, expected speed, or expected route of the first terminal device; information about a target node; or a V2X service type or priority; and receiving a second message from the first assistance device, the second message indicating that the first assistance device is to provide assistance transmission for the electronic device.

In an embodiment, the first message includes direction information for transmission from the electronic device to the first assistance device or the control device, and/or the second message includes direction information for transmission from the electronic device to the first assistance device, and the processing circuit is further configured to: based on the direction information, direct transmission from the electronic device to the first assistance device or the control device.

FIG. 12C illustrates a third example method for communication according to an embodiment of the present disclosure. The method may be performed by an assistance device (such as a RIS device 1000). As shown in FIG. 12C, the method 1200C may include receiving a first assistance transmission request signal from a first terminal device, the first assistance transmission request signal indicating at least one of: a location, expected speed, or expected route of the first terminal device; information about a target node; or a V2X service type or priority (block 1202C). The method may further include based on the first assistance transmission request signal, determining that the assistance device is to provide assistance transmission for the first terminal device (block 1204C). Further details of the method may be understood with reference to the description above with respect to the assistance device.

In an embodiment, determining that the assistance device is to provide assistance transmission for the first terminal device includes: determining a distance from the assistance device to the target node; determining signal quality of transmission from the first terminal device; and when the signal quality is insufficient to support effective transmission over the distance, determining that the assistance device is to provide assistance transmission for the first terminal device.

FIG. 12D illustrates a fourth example method for communication according to an embodiment of the present disclosure. The method may be performed by a control device (such as an electronic device 400A) or a network function (such as a PCF or an AMF). As shown in FIG. 12D, the method 1200D may include: based on a resonance frequency of an electromagnetic unit of a RIS device, determining a resource for transmission from a first terminal device to the RIS device (block 1202D). The method may further include indicating the transmission resource to the first terminal device (block 1204D). Further details of the method may be understood with reference to the description above with respect to the corresponding control device or network function entity.

Various exemplary electronic devices and methods according to embodiments of the present disclosure have been described above. It should be understood that the operations or functions of these electronic devices may be combined with each other to achieve more or less operations or functions than described. The operational steps of the methods can also be combined with each other in any suitable order, so that similarly more or fewer operations are achieved than described.

It should be understood that the machine-executable instructions in the machine-readable storage medium or program product according to the embodiments of the present disclosure can be configured to perform operations corresponding to the device and method embodiments described above. When referring to the above device and method embodiments, the embodiments of the machine-readable storage medium or the program product are clear to those skilled in the art, and therefore description thereof will not be repeated herein. A machine-readable storage media and a program product for carrying or including the above-described machine-executable instructions also fall within the scope of the present disclosure. Such storage medium can include, but is not limited to, a floppy disk, an optical disk, a magneto-optical disk, a memory card, a memory stick, and the like. In addition, it should be understood that the above series of processing and devices may alternatively be implemented by software and/or firmware.

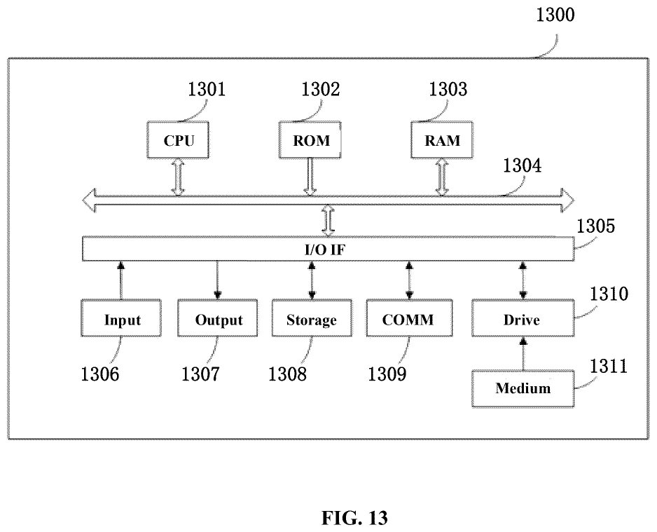

In addition, it should be understood that the above series of processing and devices may alternatively be implemented by software and/or firmware n the case of implementation by software and/or firmware, a program constituting the software is installed from a storage medium or a network to a computer having a dedicated hardware configuration, such as a general-purpose computer 1300 shown in FIG. 13. When various programs are installed, the computer is capable of performing various functions and so on. FIG. 13 is an example block diagram of a computer capable of being implemented as a terminal device or control device according to an embodiment of the present disclosure.

In FIG. 13, a central processing unit (CPU) 1301 executes various processing based on a program stored in a read-only memory (ROM) 1302 or a program loaded from a storage portion 1308 to a random access memory (RAM) 1303. The RAM 1303 also stores data required for executing various processing and the like by the CPU 1301 when necessary.

The CPU 1301, the ROM 1302, and the RAM 1303 are connected with each other via a bus 1304. An input/output port 1305 is also connected to the bus 1304.

The following components are connected to the input/output port 1305: an input part 1306, including a keyboard, a mouse, and the like; an output part 1307, including a display such as a cathode-ray tube (CRT) and a liquid crystal display (LCD), a speaker, and the like; a storage part 1308, including a hard disk and the like; and a communication part 1309, including a network interface card such as a LAN card or a modem. The communication part 1309 performs communication processing via a network such as the Internet.

Based on needs, a drive 1310 is also connected to the input/output port 1305. A removable medium 1311 such as a magnetic disk, an optical disc, a magneto-optical disk, a semiconductor memory, or the like is mounted on the drive 1310 when necessary, so that a computer program read therefrom is installed in the storage part 1308 when necessary.

In a case that the foregoing series of processing are implemented by software, programs constituting the software are installed from a network such as the Internet or a storage medium such as the removable medium 1311.

Those skilled in the art should understand that such a storage medium is not limited to the removable medium 1311 shown in FIG. 13, in which the program is stored and distributed independent from a device to provide the program for users. For example, the removable medium 1311 includes a magnetic disk (including a floppy disk (registered trademark)), an optical disc (including a compact disk read-only memory (CD-ROM) and a digital versatile disk (DVD)), a magneto-optical disc (including a mini disk (MD) (registered trademark)), and a semiconductor memory. Alternatively, the storage medium may be the ROM 1302, a hard disk included in the storage part 1308, or the like, in which the program is stored, and may be distributed to users along with a device including the storage medium.

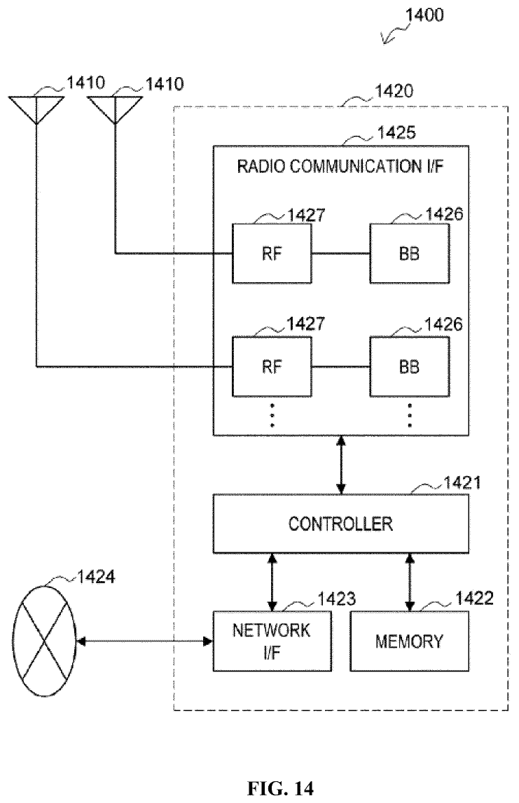

Use cases according to the present disclosure will be described below with reference to FIGS. 14 to 17.

### Use Cases for the Base Station

### First Use Case

FIG. 14 is a block diagram illustrating a first example of a schematic configuration of a gNB to which the technology in content of the present disclosure is applicable. The gNB 1400 includes a plurality of antennas 1410 and a base station device 1420. The base station device 1420 and each antenna 1410 may be connected to each other via an RF cable. In one implementation, the gNB 1400 (or base station device 1420) herein may correspond to the electronic devices 400A and/or 400C described above.

Each of the antennas 1410 includes a single or multiple antenna elements (such as multiple antenna elements included in a multiple input and multiple output (MIMO) antenna), and is used for the base station device 1420 to transmit and receive radio signals. As shown in FIG. 14, the gNB 1400 may include multiple antennas 1410. For example, multiple antennas 1410 may be compatible with multiple frequency bands used by the gNB 1400.

The base station device 1420 includes a controller 1421, a memory 1422, a network interface 1423, and a radio communication interface 1425.

The controller 1421 may be, for example, a CPU or a DSP, and operates various functions of higher layers of the base station device 1420. For example, controller 1421 generates data packets from data in signals processed by the radio communication interface 1425, and transfers the generated packets via the network interface 1423. The controller 1421 can bundle data from multiple baseband processors to generate the bundled packets, and transfer the generated bundled packets. The controller 1421 may have logic functions of performing control such as radio resource control, radio bearer control, mobility management, admission control, and scheduling. This control may be performed in corporation with a gNB or a core network node in the vicinity. The memory 1422 includes a RAM and a ROM, and stores a program that is executed by the controller 1421 and various types of control data (such as a terminal list, transmission power data, and scheduling data).

The network interface 1423 is a communication interface for connecting the base station device 1420 to the core network 1424. The controller 1421 may communicate with a core network node or another gNB via the network interface 1423. In this case, the gNB 1400 and the core network node or other gNBs may be connected to each other through a logical interface (such as an SI interface and an X2 interface). The network interface 1423 may also be a wired communication interface or a radio communication interface for radio backhaul lines. If the network interface 1423 is a radio communication interface, the network interface 1423 may use a higher frequency band for radio communication than a frequency band used by the radio communication interface 1425.

The radio communication interface 1425 supports any cellular communication schemes (such as Long Term Evolution (LTE) and LTE-Advanced), and provides, via the antenna 1410, radio connection to a terminal located in a cell of the gNB 1400. The radio communication interface 1425 may typically include, for example, a baseband (BB) processor 1426 and a RF circuit 1427. The BB processor 1426 may perform, for example, encoding/decoding, modulation/demodulation, and multiplexing/demultiplexing, and performs various types of signal processing of layers (such as L1, Medium Access Control (MAC), Radio Link Control (RLC), and Packet Data Convergence Protocol (PDCP)) instead of the controller 1421, the BB processor 1426 may have a part or all of the above-described logic functions. The BB processor 1426 may be a memory that stores a communication control program, or a module that includes a processor configured to execute the program and a related circuit. Updating the program may allow the functions of the BB processor 1426 to be changed. The module may be a card or a blade that is inserted into a slot of the base station device 1420. Alternatively, the module may also be a chip that is mounted on the card or the blade. Meanwhile, the RF circuit 1427 may include, for example, a mixer, a filter, and an amplifier, and transmits and receives radio signals via the antenna 1410. Although FIG. 14 illustrates the example in which one RF circuit 1427 is connected to one antenna 1410, the present disclosure is not limited to thereto; rather, one RF circuit 1427 may connect to a plurality of antennas 1410 at the same time.

As illustrated in FIG. 14, the radio communication interface 1425 may include the multiple BB processors 1426. For example, the multiple BB processors 1426 may be compatible with multiple frequency bands used by gNB 1400. As illustrated in FIG. 14, the radio communication interface 1425 may include the multiple RF circuits 1427. For example, the multiple RF circuits 1427 may be compatible with multiple antenna elements. Although FIG. 14 illustrates the example in which the radio communication interface 1425 includes the multiple BB processors 1426 and the multiple RF circuits 1427, the radio communication interface 1425 may also include a single BB processor 1426 or a single RF circuit 1427.

### Second Use Case

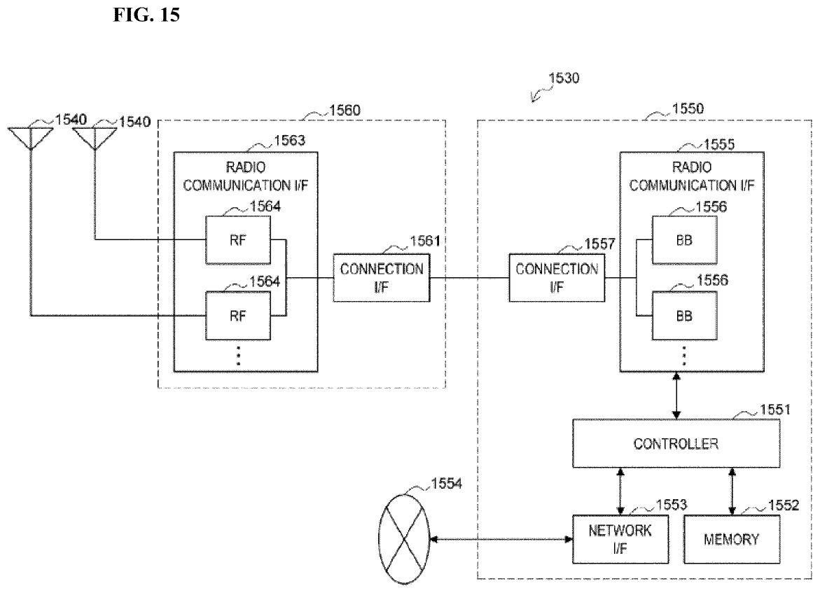

FIG. 15 is a block diagram illustrating a second example of a schematic configuration of a gNB to which the technology in content of the present disclosure is applicable. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high speed line such as a fiber optic cable. In one implementation, the gNB 1530 (or base station device 1550) herein may correspond to the electronic devices 400A and/or 400C described above.

Each of the antennas 1540 includes a single or multiple antenna elements such as multiple antenna elements included in a MIMO antenna and is used for the RRH 1560 to transmit and receive radio signals. As shown in FIG. 15, the gNB 1530 may include multiple antennas 1540. For example, multiple antennas 1540 may be compatible with multiple frequency bands used by the gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 14.

The radio communication interface 1555 supports any cellular communication scheme (such as LTE and LTE-Advanced) and provides radio communication to terminal devices positioned in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 14, except that the BB processor 1556 is connected to the RF circuit 1564 of the RRH 1560 via the connection interface 1557. As illustrated in FIG. 15, the radio communication interface 1555 may include the multiple BB processors 1556. For example, the multiple BB processors 1556 may be compatible with multiple frequency bands used by gNB 1530. Although FIG. 15 illustrates the example in which the radio communication interface 1555 includes multiple BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-described high speed line that connects the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-described high speed line.

The radio communication interface 1563 transmits and receives radio signals via the antenna 1540. The radio communication interface 1563 may typically include, for example, the RF circuitry 1564. The RF circuit 1564 may include, for example, a mixer, a filter, and an amplifier, and transmits and receives radio signals via the antenna 1540. Although FIG. 15 illustrates the example in which one RF circuit 1564 is connected to one antenna 1540, the present disclosure is not limited to thereto; rather, one RF circuit 1564 may connect to a plurality of antennas 1540 at the same time.

As illustrated in FIG. 15, the radio communication interface 1563 may include the multiple

RF circuits 1564. For example, the multiple RF circuits 1564 may support multiple antenna elements. Although FIG. 15 illustrates the example in which the radio communication interface 1563 includes the multiple RF circuits 1564, the radio communication interface 1563 may also include a single RF circuit 1564.

### [Use Cases for the Terminal Device]

### First Use Case

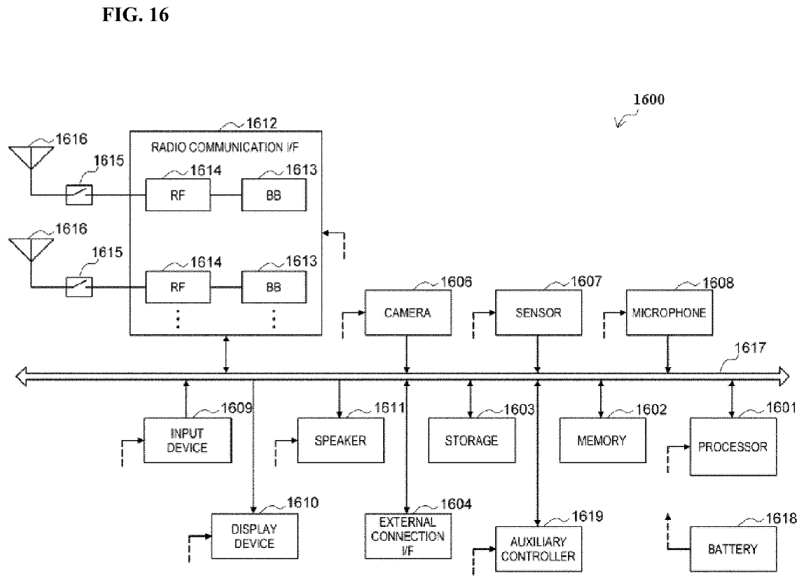

FIG. 16 is a block diagram illustrating an example of a schematic configuration of an smartphone 1600 to which the technology of the present disclosure can be applied. A smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619. In an implementation, the smartphone 1600 (or the processor 1601) herein may correspond to the above-described electronic device 400B.

The processor 1601 may be, for example, a CPU or a system on a chip (SoC), and controls functions of the application layer and other layers of the smartphone 1600. The memory 1602 includes a RAM and a ROM, and stores a program that is executed by the processor 1601. The storage device 1603 may include a storage medium such as a semiconductor memory and a hard disk. The external connection interface 1604 is an interface for connecting an external device (for example, a memory card and a universal serial bus (USB) device) to the smartphone 1600.

The camera device 1606 includes an image sensor (for example, a charge coupled device (CCD) and a complementary metal oxide semiconductor (CMOS)), and generates a captured image. The sensor 1607 may include a set of sensors, such as a measurement sensor, a gyro sensor, a geomagnetic sensor, and an acceleration sensor. The microphone 1608 converts the sound input of the smart phone 1600 into an audio signal. The input device 1609 includes, for example, a touch sensor configured to detect touches on the screen of the display device 1610, a keypad, a keyboard, buttons, or switches, and receives input operations or information of a user. The display device 1610 includes a screen (for example, a liquid crystal display (LCD) and an organic light emitting diode (OLED) display), and displays output images of the smartphone 1600. The speaker 1611 converts output audio signals of the smartphone 1600 into sound.

The radio communication interface 1612 supports any cellular communication scheme (such as LTE, LTE-Advanced, and NR) and performs radio communication. The radio communication interface 1612 may typically include, for example, a BB processor 1613 and an RF circuit 1614. The BB processor 1613 may perform, for example, encoding/decoding, modulation/demodulation, and multiplexing/demultiplexing, and performs various types of signal processing for radio communication. Meanwhile, the RF circuit 1614 may include, for example, a mixer, a filter, and an amplifier, and transmits and receives radio signals via the antenna 1616. The radio communication interface 1612 may be a chip module on which the BB processor 1613 and the RF circuit 1614 are integrated. As shown in FIG. 16, the radio communication interface 1612 may include multiple BB processors 1613 and multiple RF circuits 1614. Although FIG. 16 illustrates the example in which the radio communication interface 1612 includes the multiple BB processors 1613 and the multiple RF circuits 1614, the radio communication interface 1612 may also include a single BB processor 1613 or a single RF circuit 1614.

In addition to a cellular communication scheme, the radio communication interface 1612 can support other types of radio communication schemes, such as a short-range wireless communication scheme, a near-field communication scheme, and a wireless local area network (LAN) scheme. In this case, the radio communication interface 1612 may include the BB processor 1613 and the RF circuit 1614 as to each radio communication scheme.

Each of the antenna switches 1615 switches the connection destination of the antenna 1616 among multiple circuits (for example, circuits for different radio communication schemes) included in the radio communication interface 1612.

Each of the antennas 1616 includes one or more antenna elements (such as multiple antenna elements included in a MIMO antenna), and is used for the radio communication interface 1612 to transmit and receive radio signals. As shown in FIG. 16, the smartphone 1600 may include multiple antennas 1616. Although FIG. 16 illustrates an example in which the smartphone 1600 includes multiple antennas 1616, the radio communication interface 1600 may alternatively include a single antenna 1616.

In addition, the smartphone 1600 may include the antennas 1616 for every radio communication scheme. In this case, the antenna switch 1615 can be removed from configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619. The battery 1618 provides power for various blocks of the smartphone 1600 illustrated in FIG. 16 via feeders, and the feeders are partially expressed as dashed lines in the figure. The auxiliary controller 1619, for example, operates the minimum necessary functions of the smartphone 1600 in sleep mode.

### Second Use Case

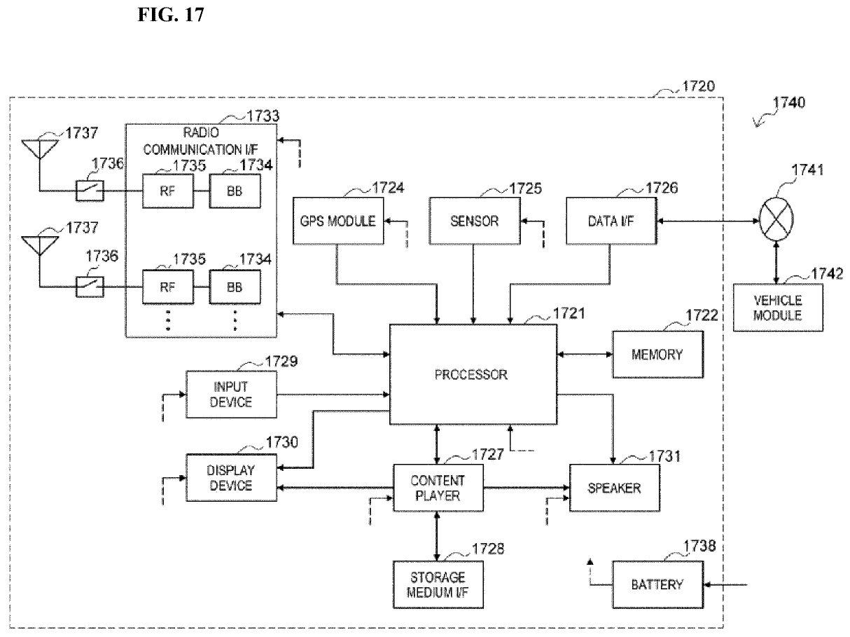

FIG. 17 is a block diagram illustrating an example of a schematic configuration of a car navigation device 1720 to which the technology of the present disclosure can be applied car navigation device 1720 includes a processor 1721, a memory 1722, a global positioning system (GPS) 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738. In an implementation, the car navigation device 1720 (or the processor 1721) herein may correspond to the above-described electronic device 400B.

The processor 1721 may be, for example, a CPU or a SoC, and controls the navigation function and other functions of the car navigation device 1720. The memory 1722 includes a RAM and a ROM, and stores a program that is executed by the processor 1721.

The GPS module 1724 performs measurement on a location (such as a latitude, a longitude, and an altitude) of the car navigation device 1720 by using GPS signals received from GPS satellites. The sensor 1725 may include a set of sensors, such as a gyro sensor, a geomagnetic sensor, and an air pressure sensor. The data interface 1726 is connected to, for example, an in-vehicle network 1741 via a terminal not shown, and acquires data generated by the vehicle (such as vehicle speed data).

The content player 1727 plays back content stored in a storage medium (such as a CD and a DVD), which is inserted into the storage medium interface 1728. The input device 1729 includes, for example, a touch sensor configured to detect touches on the screen of the display device 1730, buttons, or switches, and receives input operations or information of a user. The display device 1730 includes a screen, for example, an LCD or OLED screen, and displays images for the navigation function or playback content. The speaker 1731 outputs the sound for the navigation function or playback content.

The radio communication interface 1733 supports any cellular communication scheme (such as LTE, LTE-Advanced, and NR) and performs radio communication. The radio communication interface 1733 may typically include, for example, a BB processor 1734 and an RF circuit 1735. The BB processor 1734 may perform, for example, encoding/decoding, modulation/demodulation, and multiplexing/demultiplexing, and performs various types of signal processing for radio communication. Meanwhile, the RF circuit 1735 may include, for example, a mixer, a filter, and an amplifier, and transmits and receives radio signals via the antenna 1737. The radio communication interface 1733 may alternatively be a chip module on which the BB processor 1734 and the RF circuit 1735 are integrated. As shown in FIG. 17, the radio communication interface 1733 may include multiple BB processors 1734 and multiple RF circuits 1735. Although FIG. 17 illustrates the example in which the radio communication interface 1733 includes the multiple BB processors 1734 and the multiple RF circuits 1735, the radio communication interface 1733 may also include a single BB processor 1734 or a single RF circuit 1735.

In addition to a cellular communication scheme, the radio communication interface 1733 can support other types of radio communication schemes, such as a short-range wireless communication scheme, a near-field communication scheme, and a wireless LAN scheme. In this case, the radio communication interface 1733 may include the BB processor 1734 and the RF circuit 1735 as to each radio communication scheme.

Each of the antenna switches 1736 switches the connection destination of the antenna 1737 among multiple circuits (for example, circuits for different radio communication schemes) included in the radio communication interface 1733.

Each of the antennas 1737 includes one or more antenna elements (such as multiple antenna elements included in a MIMO antenna), and is used for the radio communication interface 1733 to transmit and receive radio signals. As shown in FIG. 17, the car navigation device 1720 may include multiple antennas 1737. Although FIG. 17 illustrates an example in which the car navigation device 1720 includes multiple antennas 1737, the car navigation device 1720 may alternatively include a single antenna 1737.

In addition, the car navigation device 1720 may include the antenna 1737 for every radio communication scheme. In this case, the antenna switch 1736 can be removed from configuration of the car navigation device 1720.

The battery 1738 provides power for various blocks of the car navigation device 1720 illustrated in FIG. 17 via feeders, and the feeders are partially expressed as dashed lines in the figure. The battery 1738 accumulates power supplied by the vehicle.

The technology of the present disclosure may also be implemented as an in-vehicle system (or vehicle) 1740 including one or more blocks of the car navigation device 1720, the in-vehicle network 1741, and a vehicle module 1742 the vehicle module 1742 generates vehicle data (such as vehicle speed, engine speed, and failure information), and outputs the generated data to the in-vehicle network 1741.

It should be understood that the following example implementations may be used to implement the technical solutions of the present disclosure.

1. An electronic device, including a processing circuit configured to:
determine a V2X communication policy for a specific area, where the V2X communication policy includes at least one of service control information, communication assistance information, and transmission control information; and
transmit the V2X communication policy, enabling a first terminal device to obtain the V2X communication policy.

2. The electronic device of clause 1, where the V2X communication policy is determined based on at least one of communication status information, road environment information, and road traffic information associated with the specific area, and where:
the communication status information includes at least one of communication resources status, a number of terminal devices, service types, and quality of service (QOS) associated with the specific area;
the road environment information includes at least one of a road section type, road section status, and obstruction information; and/or
the road traffic information includes at least one of vehicle attributes, vehicle distribution, and traffic status.

3. The electronic device of clause 1, where
the service control information is used to indicate at least one of an allowed service, a prioritized service and a restricted service in the specific area;
the communication assistance information is used to indicate at least one of an assistance device and an unreliable area in the specific area; and/or
the transmission control information is used to indicate at least one of transmittable message versions, limits on packet extension content, transmission intervals, a packet size and transmission redundancy in the specific area,
where the V2X communication policy further includes at least one of area identification information, a policy identifier, and a device identifier of the electronic device.

4. The electronic device of clause 3, where the processing circuit is further configured to: adjust the V2X communication policy for the specific area, based on at least one of updated communication status information, updated road environment information, and updated road traffic information,
where the specific area corresponds to a block, a road section, an intersection, or a specific scene.

5. The electronic device of clause 3, where the processing circuit is further configured to:
define a first sub-area of the specific area as an unreliable area, based on QoS of one or more terminal devices in the first sub-area being lower than a threshold;
define a second sub-area of the specific area as an unreliable area, based on presence of an obstruction or interference source affecting transmission in the second sub-area; and/or
define a third sub-area of the specific area as an unreliable area, based on historical QoS information in the third sub-area.

6. The electronic device of clause 5, where
assistance device information is used to indicate at least one of a device type, location, and coverage of one or more assistance devices, where the device type includes a relay node or a Reconfigurable Intelligent Surface (RIS) device.

7. The electronic device of clause 6, where the processing circuit is further configured to:
receive an assistance transmission request from the first terminal device, the assistance transmission request indicating at least one of: a location, expected speed, or expected route of the first terminal device; information about a target node; or a V2X service type or priority,
based on the assistance transmission request and the assistance device information, determine that a first assistance device is to provide assistance transmission for the first terminal device, where the first assistance device is a relay node or a RIS device; and
transmit a first message to the first terminal device and transmit a second message to the first assistance device.

8. The electronic device of clause 7, where
the first message includes direction information for transmission from the electronic device to the first assistance device; and/or
the second message includes direction information for transmission from the first assistance device to the target node.

9. The electronic device of clause 5, where the processing circuit is further configured to:
receive an assistance transmission request from the first terminal device, the assistance transmission request indicating at least one of: a location, expected speed, or expected route of the first terminal device; information about a target node; or a V2X service type or priority,
based on the assistance transmission request, determine that the electronic device is to provide assistance transmission for the first terminal device, and
transmit a third message to the first terminal device.

10. The electronic device of clause 9, where determining that the electronic device is to provide assistance transmission for the first terminal device includes:
determining a transmission distance from the electronic device to the target node;
determining signal quality of transmission from the first terminal device; and
when the signal quality is insufficient to support effective transmission over the transmission distance, determining that the electronic device is to provide assistance transmission for the first terminal device.

11. The electronic device of clause 7, where the electronic device is implemented as a base station, and the first assistance device is implemented as a RIS device; where the processing circuit is further configured to:
based on a resonance frequency of an electromagnetic unit of the RIS device, determine a resource for transmission from the first terminal device to the RIS device; and
indicate the frequency information to the first terminal device;
where the resource corresponds to at least one of a band, a frequency, a carrier, or a BWP.

12. The electronic device of any of previous clauses, where the electronic device is implemented as at least one of a base station, a roadside subsystem, an application server, and a central subsystem.

13. An electronic device, including a processing circuit configured to:
receive one or more V2X communication policies, where the one or more V2X communication policies are used for respective areas;
based on its own location, determine a first V2X communication policy corresponding to its own location from the one or more V2X communication policies, where the first V2X communication policy includes at least one of service control information, communication assistance information, and transmission control information; and
apply the first V2X communication policy.

14. The electronic device of clause 13, where applying the first V2X communication policy includes:
based on at least one of an allowed service, a prioritized service, and a restricted service indicated by the service control information, determining a type of service to be executed;
transmitting an assistance transmission request based on at least one of an unreliable area or an assistance device indicated by the communication assistance information; and/or
based on the transmission control information, determining at least one of transmittable message versions, limits on packet extension content, transmission intervals, a packet size, and transmission redundancy.

15. The electronic device of clause 14, where transmitting the assistance transmission request includes:
transmitting the assistance transmission request to a control device, the assistance transmission request indicating at least one of: a location, expected speed or expected route of a first terminal device; information about a target node; or a V2X service type or priority, and
receiving a first message from the control device, the first message indicating that a first assistance device or the control device is to provide assistance transmission for the electronic device.

16. The electronic device of clause 15, where transmitting the assistance transmission request includes:
transmitting the assistance transmission request to the first assistance device, the assistance transmission request indicating at least one of: a location, expected speed, or expected route of the first terminal device; information about a target node; or a V2X service type or priority, and
receiving a second message from the first assistance device, the second message indicating that the first assistance device is to provide assistance transmission for the electronic device.

17. The electronic device of clause 15 or 16, where the first message includes direction information for transmission from the electronic device to the first assistance device or the control device, and/or the second message includes direction information for transmission from the electronic device to the first assistance device, and the processing circuit is further configured to:
based on the direction information, direct transmission from the electronic device to the first assistance device or the control device.

18. The electronic device according to any of previous clauses, where the electronic device is implemented as an OBU or a vehicle.

19. An assistance device, including a processing circuit configured to:
receive a first assistance transmission request signal from a first terminal device, the first assistance transmission request signal indicating at least one of: a location, expected speed, or expected route of the first terminal device; information about a target node; or a V2X service type or priority, and
based on the first assistance transmission request signal, determine that the assistance device is to provide assistance transmission for the first terminal device.

20. The electronic device of clause 19, where determining that the assistance device is to provide assistance transmission for the first terminal device includes:
determining a distance from the assistance device to the target node;
determining signal quality of transmission from the first terminal device; and
when the signal quality is insufficient to support effective transmission over the distance, determining that the assistance device is to provide assistance transmission for the first terminal device.

21. The assistance device according to clause 19 or 20, where the assistance device is implemented as a Reconfigurable Intelligent Surface (RIS), and the processing circuit is further configured to dynamically adjust the RIS based on the first assistance transmission request signal.

22. An electronic device for implementing a network function, the electronic device including a processing circuit configured to:
based on a resonance frequency of an electromagnetic unit of a Reconfigurable Intelligent Surface (RIS) device, determine a resource for transmission from a first terminal device to the RIS device; and
indicating the resource to the first terminal device over a network,
where the resource corresponds to at least one of a band, a frequency, a carrier, or a BWP.

23. A communication method, including:
by a control device:
determining a V2X communication policy for a specific area, where the V2X communication policy includes at least one of service control information, communication assistance information, and transmission control information; and
transmitting the V2X communication policy, enabling a first terminal device to obtain the V2X communication policy.

24. A communication method, including:
by a terminal device:
receiving one or more V2X communication policies, where the one or more V2X communication policies are used for respective areas;
based on its own location, determining a first V2X communication policy corresponding to its own location from the one or more V2X communication policies, where the first V2X communication policy includes at least one of service control information, communication assistance information, and transmission control information; and
applying the first V2X communication policy.

25. A communication method, including:
by an assistance device:
receiving a first assistance transmission request indication from a first terminal device, the first assistance transmission request indication indicating at least one of: a location, expected speed, or expected route of the first terminal device; information about a target node; or a V2X service type or priority, and
based on the first assistance transmission request indication, determining that the assistance device is to provide assistance transmission for the first terminal device.

26. A communication method, including:
based on a resonance frequency of an electromagnetic unit of a Reconfigurable Intelligent Surface (RIS) device, determining a resource for transmission from a first terminal device to the RIS device; and
indicating the resource to the first terminal device;
where the resource corresponds to at least one of a band, a frequency, a carrier, or a BWP.

27. A computer-readable storage medium having executable instructions stored thereon, where the executable instructions, when executed by one or more processors, cause implementation of operations of the method of any of clauses 23 to 26.

28. A computer program product, where the computer program product includes instructions which, when executed by a computer, cause implementation of the method of any of clauses 23 to 26.

The exemplary embodiments of the present disclosure have been described above with reference to the drawings, but the present disclosure is of course not limited to the above examples. Those skilled in the art can obtain various changes and modifications within the scope of the appended claims, and it should be understood that these changes and modifications will naturally fall within the technical scope of the present disclosure.

For example, a plurality of functions included in one unit in the above embodiments may be implemented by separate devices. Alternatively, the multiple functions implemented by the multiple units in the above embodiments may be implemented by separate devices, respectively. In addition, one of the above functions can be realized by multiple units. Needless to say, such a configuration is included in the technical scope of the present disclosure.

In this specification, the steps described in the flowchart include not only processes performed in time series in the described order, but also processes performed in parallel or individually rather than necessarily in time series. In addition, even in the steps processed in time series, needless to say, the order can be changed appropriately.

Although the present disclosure and its advantages have been described in detail, it should be understood that various modifications, replacements, and changes can be made without departing from the spirit and scope of the present disclosure as defined by the appended claims. Moreover, the terms “include”, “comprise”, or their any other variant in the embodiments of the present disclosure is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

1. An electronic device, comprising a processing circuit configured to:
determine a V2X communication policy for a specific area, wherein the V2X communication policy comprises at least one of service control information, communication assistance information, and transmission control information; and
transmit the V2X communication policy, enabling a first terminal device to obtain the V2X communication policy.

2. The electronic device of claim 1, wherein the V2X communication policy is determined based on at least one of communication status information, road environment information, and road traffic information associated with the specific area, and wherein:
the communication status information comprises at least one of communication resources status, a number of terminal devices, service types, and quality of service (QOS) associated with the specific area;
the road environment information comprises at least one of a road section type, road section status, and obstruction information; and/or
the road traffic information comprises at least one of vehicle attributes, vehicle distribution, and traffic status.

3. The electronic device of claim 1, wherein:
the service control information is used to indicate at least one of an allowed service, a prioritized service and a restricted service in the specific area;
the communication assistance information is used to indicate at least one of an assistance device and an unreliable area in the specific area; and/or
the transmission control information is used to indicate at least one of transmittable message versions, limits on packet extension content, transmission intervals, a packet size and transmission redundancy in the specific area,
wherein the V2X communication policy further comprises at least one of area identification information, a policy identifier, and a device identifier of the electronic device.

4. The electronic device of claim 3, wherein the processing circuit is further configured to: adjust the V2X communication policy for the specific area, based on at least one of updated communication status information, updated road environment information, and updated road traffic information, wherein the specific area corresponds to a block, a road section, or an intersection; and/or
wherein the processing circuit is further configured to:
define a first sub-area of the specific area as an unreliable area, based on QoS of one or more terminal devices in the first sub-area being lower than a threshold;
define a second sub-area of the specific area as an unreliable area, based on presence of an obstruction or interference source affecting transmission in the second sub-area; and/or
define a third sub-area of the specific area as an unreliable area, based on historical Qos information in the third sub-area.

5. (canceled)

6. The electronic device of claim 4, wherein:
assistance device information is used to indicate at least one of a device type, location, and coverage of one or more assistance devices, wherein the device type comprises a relay node or a Reconfigurable Intelligent Surface (RIS) device.

7. The electronic device of claim 6, wherein the processing circuit is further configured to:
receive an assistance transmission request from the first terminal device, the assistance transmission request indicating at least one of: a location, expected speed, or expected route of the first terminal device; information about a target node; or a V2X service type or priority,
based on the assistance transmission request and the assistance device information, determine that a first assistance device is to provide assistance transmission for the first terminal device, wherein the first assistance device is a relay node or a RIS device; and
transmit a first message to the first terminal device and transmit a second message to the first assistance device.

8. The electronic device of claim 7, wherein:
the first message comprises direction information for transmission from the electronic device to the first assistance device; and/or
the second message comprises direction information for transmission from the first assistance device to the target node.

9. The electronic device of claim 4, wherein the processing circuit is further configured to:
receive an assistance transmission request from the first terminal device, the assistance transmission request indicating at least one of: a location, expected speed, or expected route of the first terminal device; information about a target node; or a V2X service type or priority,
based on the assistance transmission request, determine that the electronic device is to provide assistance transmission for the first terminal device, and
transmit a third message to the first terminal device.

10. The electronic device of claim 9, wherein determining that the electronic device is to provide assistance transmission for the first terminal device comprises:
determining a transmission distance from the electronic device to the target node;
determining signal quality of transmission from the first terminal device; and
when the signal quality is insufficient to support effective transmission over the transmission distance, determining that the electronic device is to provide assistance transmission for the first terminal device.

11. The electronic device of claim 7, wherein the electronic device is implemented as a base station, and the first assistance device is implemented as a RIS device; wherein the processing circuit is further configured to:
based on a resonance frequency of an electromagnetic unit of the RIS device, determine a resource for transmission from the first terminal device to the RIS device; and
indicate information of the resource to the first terminal device;
wherein the resource corresponds to at least one of a band, a frequency, a carrier, or a BWP.

12. The electronic device of claim 1, wherein the electronic device is implemented as at least one of a base station, a roadside subsystem, an application server, and a central subsystem.

13. An electronic device, comprising a processing circuit configured to:
receive one or more V2X communication policies, wherein the one or more V2X communication policies are used for respective areas;
based on its own location, determine a first V2X communication policy corresponding to its own location from the one or more V2X communication policies, wherein the first V2X communication policy comprises at least one of service control information, communication assistance information, and transmission control information; and
apply the first V2X communication policy.

14. The electronic device of claim 13, wherein applying the first V2X communication policy comprises:
based on at least one of an allowed service, a prioritized service, and a restricted service indicated by the service control information, determining a type of service to be executed;
transmitting an assistance transmission request based on at least one of an unreliable area or an assistance device indicated by the communication assistance information; and/or
based on the transmission control information, determining at least one of transmittable message versions, limits on packet extension content, transmission intervals, a packet size, and transmission redundancy.

15. The electronic device of claim 14, wherein transmitting the assistance transmission request comprises:
transmitting the assistance transmission request to a control device, the assistance transmission request indicating at least one of: a location, expected speed or expected route of a first terminal device; information about a target node; or a V2X service type or priority, and
receiving a first message from the control device, the first message indicating that a first assistance device or the control device is to provide assistance transmission for the electronic device.

16. The electronic device of claim 15, wherein transmitting the assistance transmission request comprises:
transmitting the assistance transmission request to the first assistance device, the assistance transmission request indicating at least one of: a location, expected speed, or expected route of the first terminal device; information about a target node; or a V2X service type or priority, and
receiving a second message from the first assistance device, the second message indicating that the first assistance device is to provide assistance transmission for the electronic device.

17. The electronic device of claim 15, wherein the first message comprises direction information for transmission from the electronic device to the first assistance device or the control device, and/or the second message comprises direction information for transmission from the electronic device to the first assistance device, and the processing circuit is further configured to:
based on the direction information, direct transmission from the electronic device to the first assistance device or the control device.

18. The electronic device according to claim 1, wherein the electronic device is implemented as an OBU or a vehicle.

19. An assistance device, comprising a processing circuit configured to:
receive a first assistance transmission request signal from a first terminal device, the first assistance transmission request signal indicating at least one of: a location, expected speed, or expected route of the first terminal device; information about a target node; or a V2X service type or priority, and
based on the first assistance transmission request signal, determine that the assistance device is to provide assistance transmission for the first terminal device.

20. The electronic device of claim 19, wherein determining that the assistance device is to provide assistance transmission for the first terminal device comprises:
determining a distance from the assistance device to the target node;
determining signal quality of transmission from the first terminal device; and
when the signal quality is insufficient to support effective transmission over the distance, determining that the assistance device is to provide assistance transmission for the first terminal device.

21. The assistance device according to claim 19, wherein the assistance device is implemented as a Reconfigurable Intelligent Surface (RIS), and the processing circuit is further configured to dynamically adjust the RIS based on the first assistance transmission request signal.

22-28. (canceled)
